(19) United States
(12) Patent Application Publication
(10) Pub. No.: US 2021/0103953 A1
(43) Pub. Date: Apr. 8, 2021

(54) CONVERSION SCORE DETERMINATION FOR TRENDING AND NON-TRENDING CONTENT

(71) Applicant: Oath Inc., New York, NY (US)

(72) Inventors: Chander Jayaraman Iyer, Santa Clara, CA (US); Srinath Ravindran, Santa Clara, CA (US); Sainath Subramanya Vellal, Sunnyvale, CA (US); Lakshmi Narayan Bhamidipati, Sunnyvale, CA (US)

(21) Appl. No.: 16/595,859

(22) Filed: Oct. 8, 2019

(51) Int. Cl. G06Q 30/02; G06F 16/9535; G06F 16/9536; G06F 16/9537; H04L 29/08; H04L 12/24

(52) U.S. Cl. CPC G06Q 30/0256; G06F 16/9535; G06F 16/9536; G06F 16/9537; H04L 41/0806; G06Q 30/0264; G06Q 30/0246; H04L 67/306; G06Q 30/0201

(57) ABSTRACT

One or more computing devices, systems, and/or methods are provided. A user profile database may be analyzed to identify a first plurality of user profiles and/or a second plurality of user profiles. A user profile of the first plurality of user profiles may be indicative of activity associated with a content item of the one or more first content items when the one or more first content items are trending. A user profile of the second plurality of user profiles may be indicative of activity associated with a content item of the one or more first content items when the one or more first content items are not trending. A first conversion score associated with a first entity may be determined based upon the first plurality of user profiles. A second conversion score associated with the first entity may be determined based upon the second plurality of user profiles.

### BACKGROUND

Many applications, such as websites, applications, etc. may provide platforms for viewing media. For example, a user may interact with a service and/or the service may use user information associated with the user to determine interests of the user. For example, media may be selected for the user based upon the interests of the user.

### SUMMARY

In accordance with the present disclosure, one or more computing devices and/or methods are provided. In an example, activity associated with a first plurality of client devices may be analyzed based upon one or more first content items to determine one or more first time periods during which the one or more first content items are trending and/or one or more second time periods during which the one or more first content items are not trending. A user profile database may be analyzed based upon the one or more first content items, the one or more first time periods and/or the one or more second time periods to identify a first plurality of user profiles associated with a first set of client devices and/or a second plurality of user profiles associated with a second set of client devices. A user profile of the first plurality of user profiles may comprise activity information, associated with a client device of the first set of client devices, indicative of activity associated with a content item of the one or more first content items within the one or more first time periods. A user profile of the second plurality of user profiles may comprise activity information, associated with a client device of the second set of client devices, indicative of activity associated with a content item of the one or more first content items within the one or more second time periods. A first conversion score associated with a first entity may be determined based upon the first plurality of user profiles. The first conversion score may be associated with a measure of conversion events associated with the first entity occurring after activity associated with the one or more first content items is performed within the one or more first time periods. A second conversion score associated with the first entity may be determined based upon the second plurality of user profiles. The second conversion score may be associated with a measure of conversion events associated with the first entity occurring after activity associated with the one or more first content items is performed within the one or more second time periods. A request for content associated with a first client device may be received. The user profile database may be analyzed to identify a first user profile associated with the first client device. The first user profile may comprise first activity information associated with the first client device. Responsive to determining that the first activity information is indicative of first activity associated with a content item of the one or more first content items, a conversion probability associated with the first client device may be determined based upon the first conversion score and/or the second conversion score. The conversion probability may correspond to a probability that a conversion event associated with the first entity is performed via the first client device. A transmission content item may be selected for transmission to the first client device based upon the conversion probability. The transmission content item may be transmitted to the first client device.

In an example, activity associated with a first plurality of client devices may be analyzed based upon one or more first content items to determine one or more first time periods during which the one or more first content items are trending and/or one or more second time periods during which the one or more first content items are not trending. A user profile database may be analyzed based upon the one or more first content items, the one or more first time periods and/or the one or more second time periods to identify a first plurality of user profiles associated with a first set of client devices and/or a second plurality of user profiles associated with a second set of client devices. A user profile of the first plurality of user profiles may comprise activity information, associated with a client device of the first set of client devices, indicative of activity associated with a content item of the one or more first content items within the one or more first time periods. A user profile of the second plurality of user profiles may comprise activity information, associated with a client device of the second set of client devices, indicative of activity associated with a content item of the one or more first content items within the one or more second time periods. A first conversion score associated with a first entity may be determined based upon the first plurality of user profiles. The first conversion score may be associated with a measure of conversion events associated with the first entity occurring after activity associated with the one or more first content items is performed within the one or more first time periods. A second conversion score associated with the first entity may be determined based upon the second plurality of user profiles. The second conversion score may be associated with a measure of conversion events associated with the first entity occurring after activity associated with the one or more first content items is performed within the one or more second time periods.

In an example, activity associated with a first plurality of client devices may be analyzed based upon one or more first content items to determine one or more first time periods during which the one or more first content items are trending and/or one or more second time periods during which the one or more first content items are not trending. A user profile database may be analyzed based upon the one or more first content items, the one or more first time periods and/or the one or more second time periods to identify a first plurality of user profiles associated with a first set of client devices and/or a second plurality of user profiles associated with a second set of client devices. A user profile of the first plurality of user profiles may comprise activity information, associated with a client device of the first set of client devices, indicative of activity associated with a content item of the one or more first content items within the one or more first time periods. A user profile of the second plurality of user profiles may comprise activity information, associated with a client device of the second set of client devices, indicative of activity associated with a content item of the one or more first content items within the one or more second time periods. A first conversion score associated with a first entity may be determined based upon the first plurality of user profiles. The first conversion score may be associated with a measure of conversion events associated with the first entity occurring after activity associated with the one or more first content items is performed within the one or more first time periods. A second conversion score associated with the first entity may be determined based upon the second plurality of user profiles. The second conversion score may be associated with a measure of conversion events associated with the first entity occurring after activity associated with the one or more first content items is performed within the one or more second time periods. A summary report may be generated based upon the first conversion score, the second conversion score, the one or more first content items, the first plurality of user profiles and/or the second plurality of user profiles.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4A is a flow chart illustrating a first portion of an example method for determining conversion scores associated with content items and/or selecting content for transmission to devices.

FIG. 4B is a flow chart illustrating a second portion of an example method for determining conversion scores associated with content items and/or selecting content for transmission to devices.

FIG. 5A illustrates an exemplary level of activity chart illustrating an example of a level of activity curve corresponding to levels of activity associated with one or more first content items.

FIG. 5B is a component block diagram illustrating an example system for determining one or more conversion scores associated with an entity, where conversion rates are determined based upon an exemplary user profile database.

FIG. 5C is a component block diagram illustrating an example system for determining one or more conversion scores associated with an entity, where conversion scores are determined based upon conversion rates.

FIG. 6A is a diagram illustrating an exemplary system for selecting content for transmission to client devices, where a first client device presents and/or accesses a first web page.

FIG. 6B is a diagram illustrating an exemplary system for selecting content for transmission to client devices, where a first client device presents a plurality of search results associated with a query.

FIG. 6C is a diagram illustrating an exemplary system for selecting content for transmission to client devices, where a first client device transmits a request to access a resource to a first server.

FIG. 6D is a diagram illustrating an exemplary system for selecting content for transmission to client devices, where a first server transmits a request for content to a second server associated with a content system.

FIG. 6E is a diagram illustrating an exemplary system for selecting content for transmission to client devices, where a first conversion probability is determined based upon a first user profile associated with a first client device.

FIG. 6F is a diagram illustrating an exemplary system for selecting content for transmission to client devices, where a first client device presents and/or accesses a fourth web page using a browser of the first client device.

FIG. 7 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

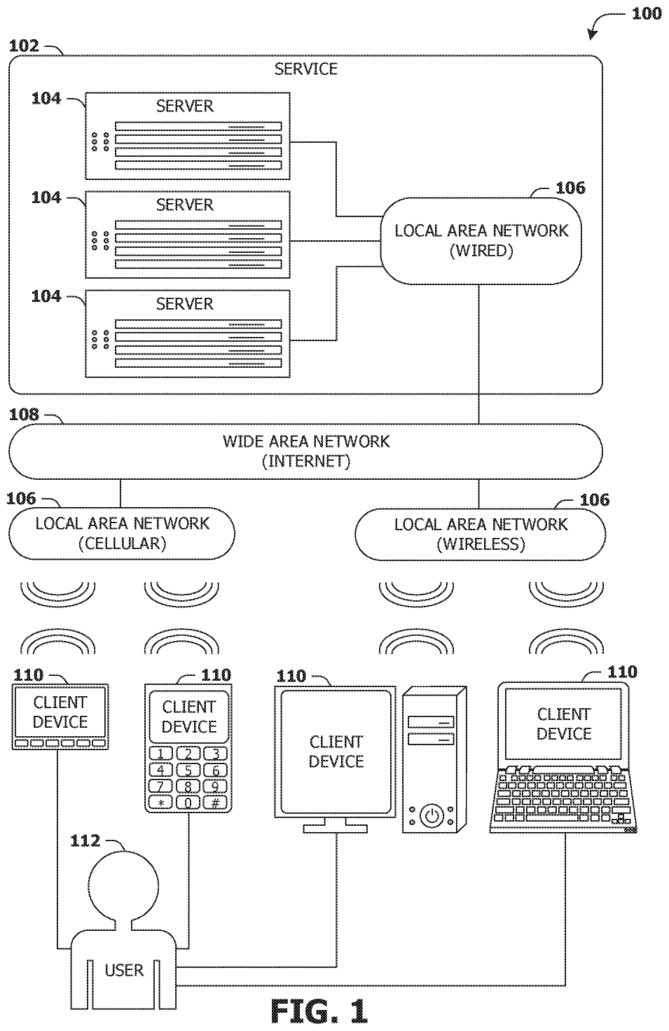

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

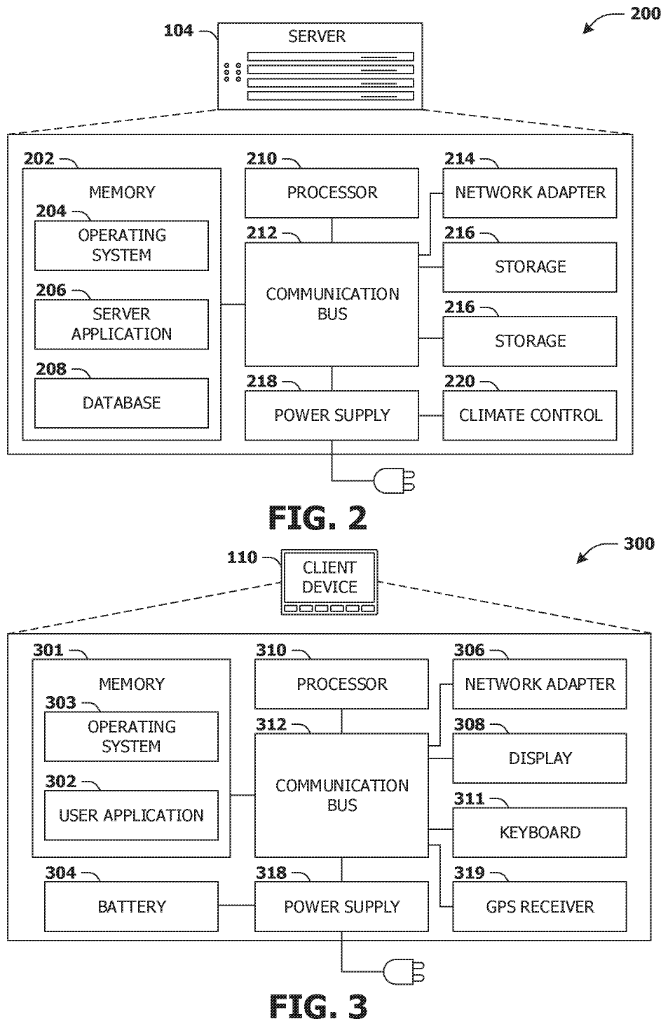

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more computing devices and/or techniques for determining conversion scores associated with content items and/or selecting content for transmission to devices are provided. For example, a user (and/or a device associated with the user) may access and/or interact with a service, such as a browser, software, a website, an application, an operating system, etc. that provides a platform for viewing and/or downloading content from a server associated with a content system. In some examples, the content system may use user information, such as one or more of activity information (e.g., search history information, website browsing history, email information, etc.), user demographic information, location information, etc. to determine interests of the user. For example, the user information may be received from the device (and/or one or more other devices associated with the user and/or a user account associated with the user). Alternatively and/or additionally, the user information may be received from servers associated with websites visited by the user, servers associated with an email account of the user, etc.

For example, it may be determined (by the content system) that the user accessed a first content item (e.g., the user consumed a website, a video, an article, etc.) associated with a first subject matter. A second content item, associated with a first entity, may be selected for the user based upon a conversion score associated with the first entity. For example, the first content item may be associated with cars, the first entity may be a first advertiser associated with a car brand and/or the conversion score may correspond to a measure of conversion events associated with the entity occurring after the first content item is accessed via client devices. However, the content system may not take into account whether the first content item was trending when the user accessed the first content item. For example, whether the first content item was trending when the first content item was accessed by the user may be an indicator of whether or not the user is likely to perform a conversion (e.g., a purchase event, purchasing of a product associated with the first entity, purchasing of a service associated with the first entity, clicking on the second content item associated with the first entity, etc.). In an example, the user accessing the first content item while the first content item is trending may be indicative of a first probability of the user performing a conversion associated with the first entity. Alternatively and/or additionally, the user accessing the first content item when the first content item is not trending may be indicative of a second probability of the user performing a conversion associated with the first entity, where the first probability may be different than the second probability.

Thus, in accordance with one or more of the techniques presented herein, information of a user profile database associated with a first plurality of client devices may be analyzed based upon the first content item to determine one or more first time periods during which the first content item is trending and/or one or more second periods during which the first content item is not trending. The user profile database may be analyzed based upon the first content item, the one or more first time periods and/or the one or more second time periods to identify a first plurality of user profiles associated with a first set of client devices and/or a second plurality of user profiles associated with a second set of client devices. A user profile of the first plurality of user profiles may comprise activity information, associated with a client device of the first set of client devices, indicative of activity associated with the first content item within the one or more first time periods. A user profile of the second plurality of user profiles may comprise activity information, associated with a client device of the second set of client devices, indicative of activity associated with the first content item within the one or more second time periods. A first conversion score associated with the first entity may be determined based upon the first plurality of user profiles. The first conversion score may correspond to a measure of conversion events associated with the first entity occurring after activity associated with the one or more first content items is performed within the one or more first time periods. A second conversion score associated with the first entity may be determined based upon the second plurality of user profiles. The second conversion score may correspond to a measure of conversion events associated with the first entity occurring after activity associated with the one or more first content items is performed within the one or more second time periods. A conversion probability associated with the first client device may be determined based upon the first conversion score and/or the second conversion score. The conversion probability may correspond to a probability that a conversion event associated with the first entity is performed via the first client device. In an example, the conversion probability may be determined based upon the first conversion score responsive to determining that the first content item is accessed by the first client device at a time that the first content item is trending. Alternatively and/or additionally, the conversion probability may be determined based upon the second conversion score responsive to determining that the first content item is accessed by the first client device at a time that the first content item is not trending.

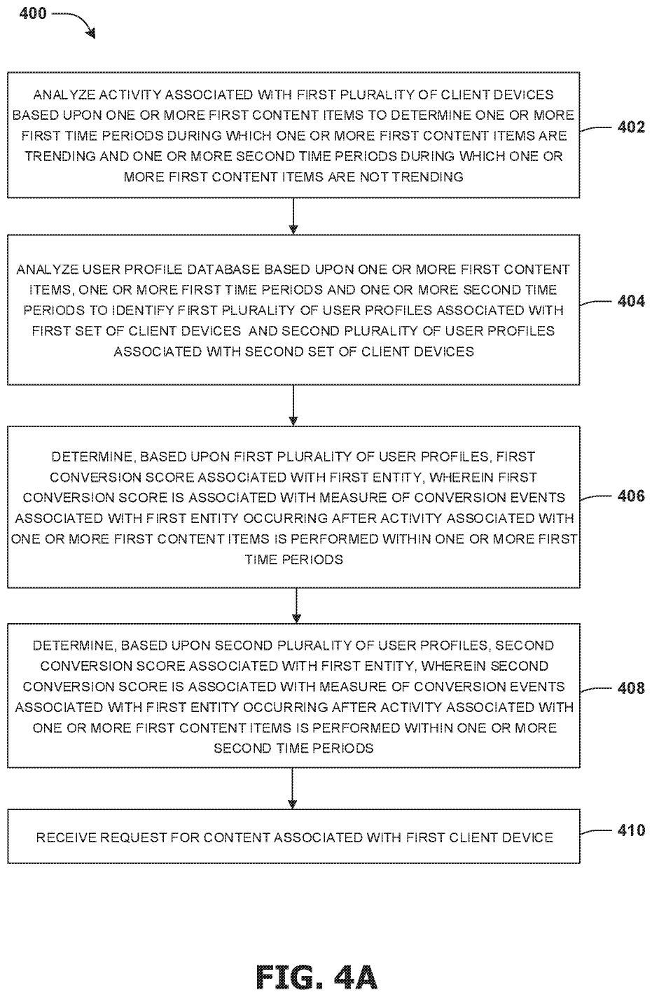

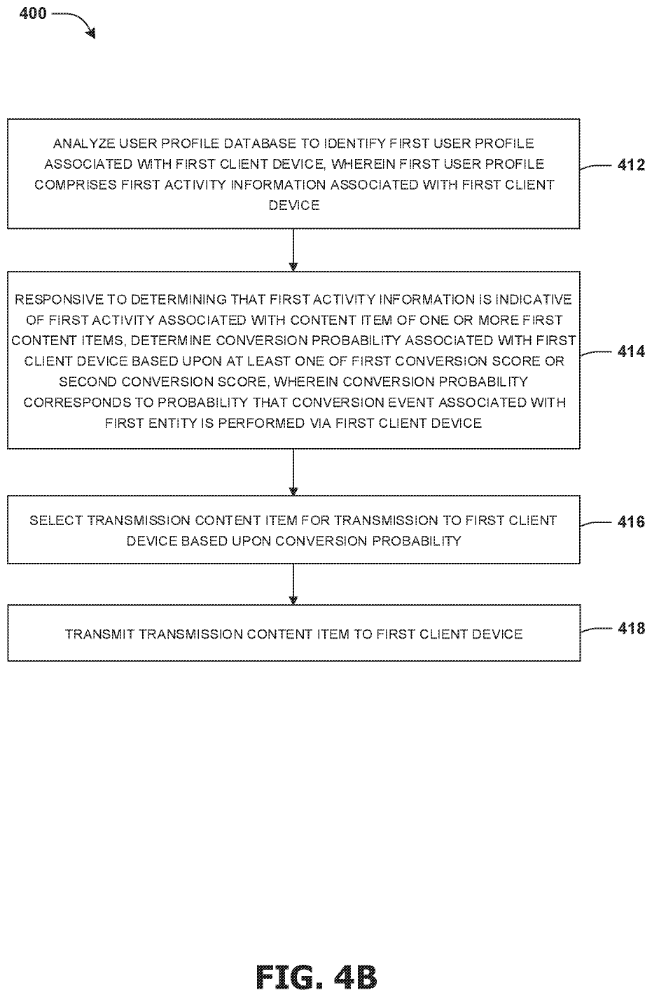

An embodiment of determining conversion scores associated with content items and/or selecting content for transmission to devices is illustrated by an example method 400 of FIGS. 4A-4B. A content system for presenting content via client devices may be provided. In some examples, the content system may be an advertisement system (e.g., an online advertising system). Alternatively and/or additionally, the content system may provide content items to be presented via pages associated with the content system. For example, the pages may be associated with websites (e.g., websites providing search engines, email services, news content, communication services, etc.) associated with the content system. The content system may provide content items to be presented in (dedicated) locations throughout the pages (e.g., one or more areas of the pages configured for presentation of content items). For example, a content item may be presented at the top of a web page associated with the content system (e.g., within a banner area), at the side of the web page (e.g., within a column), in a pop-up window, overlaying content of the web page, etc. Alternatively and/or additionally, a content item may be presented within an application associated with the content system and/or within a game associated with the content system. Alternatively and/or additionally, a user may be required to watch and/or interact with the content item before the user can access content of a web page, utilize resources of an application and/or play a game.

In some examples, the content system may provide content items for presentation via client devices based upon (past) user activity associated with the client devices. For example, the content system may generate and/or maintain a user profile database comprising a plurality of user profiles associated with a plurality of client devices and/or a plurality of user accounts (e.g., email accounts, content platform accounts for uploading content, consuming articles, videos and/or music, etc.) associated with the content system. A user profile of the plurality of user profiles may comprise user information associated with a client device and/or a user account, such as one or more of activity information, demographic information (e.g., age, gender, etc.), location information, etc. For example, the activity information may be indicative of one or more of one or more consumed content items (e.g., an article, a video, an audio file, an image, a webpage, an advertisement, an email, a message, etc. consumed by a user), one or more accessed content items (e.g., an article, a video, an audio file, an image, a webpage, an advertisement, an email, a message, etc. accessed by a client device), one or more selected content items (e.g., an article, a video, an audio file, an image, a webpage, an advertisement, an email, a message, etc. selected via a client device), one or more content item interactions (e.g., an advertisement impression, an advertisement click, a conversion associated with an advertisement, etc.), etc.

At 402, activity associated with a first plurality of client devices and/or a first plurality of user accounts may be analyzed based upon one or more first content items to determine one or more first time periods during which the one or more first content items are trending and/or one or more second time periods during which the one or more first content items are not trending. For example, activity information of the user profile database (e.g., activity information of the plurality of user profiles of the user profile database) associated with the first plurality of client devices and/or the first plurality of user accounts may be analyzed based upon the one or more first content items to determine the one or more first time periods during which the one or more first content items are trending and/or the one or more second time periods during which the one or more first content items are not trending.

In some examples, the one or more first content items may comprise one or more of one or more articles (e.g., one or more news articles, one or more informational articles, one or more blog posts, etc.), one or more videos, one or more audio files, one or more images, one or more webpages, one or more advertisements, etc. In some examples, the one or more first content items may be associated with one or more first subjects. For example, the one or more first subjects may correspond to one or more entities associated with the one or more first content items. The one or more entities may correspond to one or more of one or more places (e.g., countries, cities, geographic locations, etc.), one or more people (e.g., people of a particular location, people with a particular occupation, politicians, celebrities, socialites, etc.), things (e.g., devices, natural objects, etc.), one or more organizations, one or more companies and/or brands, one or more ideas, one or more systems, one or more events, one or more historical events, one or more current events, one or more abstract objects, one or more physical objects, etc. The one or more entities may be expressed (and/or mentioned) within the one or more first content items (e.g., the one or more first content items may comprise an article mentioning the one or more entities).

Alternatively and/or additionally, the one or more first subjects may correspond to one or more topics associated with the one or more first content items (e.g., the one or more topics may be expressed and/or discussed in the one or more first content items). In an example, the one or more topics may correspond to one or more of celebrity news, fashion, economy, politics, business, the United States, international news, the White House, entertainment, celebrity news, science news, technology, health news, travel destinations, cuisine, transportation, cost-friendliness, tourism, etc.

In some examples, an exemplary content item may be selected for inclusion in the one or more first content items responsive to determining that the exemplary content item is associated with the one or more first subjects. For example, the exemplary content item may be analyzed to determine that the exemplary content item is associated with the one or more first subjects. One or more sections of the exemplary content item may be compared with one or more information databases (e.g., one or more resources such as one or more of an encyclopedia, an online encyclopedia, a news channel, a news website, a website, a book, a research article, a research article database and/or a different type of information database, etc.) to identify the one or more first subjects. Alternatively and/or additionally, the exemplary content item may be analyzed using one or more named-entity recognition (NER) techniques to identify the one or more first subjects. Alternatively and/or additionally, the exemplary content item may be analyzed using one or more multi-label learning (MLL) techniques to identify the one or more first subjects.

In some examples, the one or more first content items may be associated with one or more first keywords. In some examples, an exemplary content item may be selected for inclusion in the one or more first content items responsive to determining that the exemplary content item is associated with the one or more first keywords. For example, the exemplary content item may be analyzed to determine that the exemplary content item is associated with the one or more first keywords. The exemplary content item may be selected for inclusion in the one or more first content items responsive to determining that a section (e.g., one or more of a title of an article, the article, a title of a video, a transcript of the video, etc.) of the exemplary content item comprises one or more words matching (e.g., the same as and/or related to) one or more keywords of the one or more first keywords. Alternatively and/or additionally, the exemplary content item may be selected for inclusion in the one or more first content items responsive to determining that a keyword mapping of the exemplary content item (e.g., a keyword mapping of a webpage associated with the exemplary content item) comprises one or more keywords matching (e.g., the same as and/or related to) one or more keywords of the one or more first keywords).

In some examples, the one or more first keywords may be associated with one or more first queries. For example, a query of the one or more first queries may comprise one or more words matching (e.g., the same as and/or related to) one or more keywords of the one or more first keywords. The exemplary content item may be selected for inclusion in the one or more first content items responsive to determining that the exemplary content item is associated with the one or more first queries. For example, it may be determined that the exemplary content item is associated with the one or more first queries based upon a determination that performing a search of a query of the one or more first queries using a search interface yields search results comprising the exemplary content item. Alternatively and/or additionally, it may be determined that the exemplary content item is associated with the one or more first queries based upon a determination that a search performed via a client device using a query of the one or more first queries yielded search results comprising the exemplary content item, and/or that the exemplary content item is selected from amongst the search results via the client device.

In some examples, the activity information associated with the first plurality of client devices may be analyzed to determine levels of activity associated with the one or more first content items. A level of activity associated with the one or more first content items may be associated with one or more of a quantity of instances that the one or more first content items are consumed (and/or a rate at which the one or more first content items are consumed), a quantity of instances that the one or more first content items are accessed (and/or a rate at which the one or more first content items are accessed), a quantity of instances that the one or more first content items are presented via client devices (e.g., and/or a rate at which the one or more first content items are presented), etc. For example, it may be determined that the one or more first content items are trending within the one or more first time periods by determining that one or more levels of activity associated with the one or more first content items during the one or more first time periods meet a threshold level of activity. Alternatively and/or additionally, it may be determined that the one or more first content items are not trending during the one or more second time periods by determining that one or more levels of activity associated with the one or more first content items during the one or more second time periods do not meet the threshold level of activity.

Alternatively and/or additionally, second activity associated with the first plurality of client devices may be analyzed based upon content items associated with the one or more first subjects (such as content items comprising the one or more first content items and/or one or more other content items associated with the one or more first subjects) to determine one or more third time periods during which the one or more first subjects are trending and/or one or more fourth time periods during which the one or more first subjects are not trending. For example, it may be determined that the one or more first subjects are trending during the one or more third time periods by determining that one or more levels of activity associated with the content items associated with the one or more first subjects meet a second threshold level of activity during the one or more third time periods. Alternatively and/or additionally, it may be determined that the one or more first subjects are not trending during the one or more fourth time periods by determining that one or more levels of activity associated with the content items associated with the one or more first subjects do not meet the second threshold level of activity during the one or more fourth time periods.

In some examples, the one or more first time periods during which the one or more first content items are trending may be determined based upon the second activity and/or the one or more third time periods during which the one or more first subjects are trending (e.g., the one or more first time periods may be the same as the one or more third time periods). Alternatively and/or additionally, the one or more second time periods during which the one or more first content items are not trending may be determined based upon the second activity and/or the one or more fourth time periods during which the one or more first subjects are not trending (e.g., the one or more second time periods may be the same as the one or more fourth time periods).

Alternatively and/or additionally, publishing activity associated with publication and/or generation of content items associated with the one or more first subjects may be analyzed to determine one or more fifth time periods during which the one or more first subjects are trending and/or one or more sixth time periods during which the one or more first subjects are not trending. For example, it may be determined that the one or more first subjects are trending during the one or more fifth time periods by determining that one or more levels of publishing activity associated with the one or more first subjects (e.g., a quantity of content items associated with the one or more first subjects that are published and/or generated and/or a rate at which content items associated with the one or more first subjects are published and/or generated) meet a threshold level of publishing activity during the one or more fifth time periods. Alternatively and/or additionally, it may be determined that the one or more first subjects are not trending during the one or more sixth time periods by determining that one or more levels of publishing activity associated with the one or more first subjects do not meet the threshold level of publishing activity during the one or more sixth time periods.

In some examples, the one or more first time periods during which the one or more first content items are trending may be determined based upon the publishing activity and/or the one or more fifth time periods during which the one or more first subjects are trending (e.g., the one or more first time periods may be the same as the one or more fifth time periods). Alternatively and/or additionally, the one or more second time periods during which the one or more first content items are not trending may be determined based upon the publishing activity and/or the one or more sixth time periods during which the one or more first subjects are not trending (e.g., the one or more second time periods may be the same as the one or more sixth time periods).

Alternatively and/or additionally, search activity associated with the first plurality of client devices may be analyzed based upon the one or more first keywords and/or the one or more first queries to determine one or more seventh time periods during which the one or more first queries are trending and/or one or more eighth time periods during which the one or more first queries are not trending. For example, it may be determined that the one or more first queries are trending during the one or more seventh time periods by determining that one or more levels of search activity associated with the one or more first queries meet a threshold level of search activity during the one or more seventh time periods. A level of search activity associated with the one or more first queries may be associated with one or more of a quantity of instances that the one or more first queries are entered into a search interface (and/or a rate at which the one or more first queries are entered into the search interface), a quantity of instances that search results associated with the one or more first queries are generated and/or presented via the search interface (and/or a rate at which search results associated with the one or more first queries are generated and/or presented via the search interface), etc. Alternatively and/or additionally, it may be determined that the one or more first queries are not trending during the one or more eighth time periods by determining that one or more levels of search activity associated with the one or more first queries do not meet the threshold level of search activity during the one or more eighth time periods.

In some examples, the one or more first time periods during which the one or more first content items are trending may be determined based upon the search activity and/or the one or more seventh time periods during which the one or more first queries are trending (e.g., the one or more first time periods may be the same as the one or more seventh time periods). Alternatively and/or additionally, the one or more second time periods during which the one or more first content items are not trending may be determined based upon the search activity and/or the one or more eighth time periods during which the one or more first queries are not trending (e.g., the one or more second time periods may be the same as the one or more eighth time periods).

At 404, the user profile database may be analyzed based upon the one or more first content items, the one or more first time periods and/or the one or more second time periods to identify a first plurality of user profiles and/or a second plurality of user profiles of the user profile database. The first plurality of user profiles may be associated with a first set of client devices and/or a first set of user accounts. Alternatively and/or additionally, the second plurality of user profiles may be associated with a second set of client devices and/or a second set of user accounts.

A user profile of the first plurality of user profiles may comprise activity information, associated with a client device of the first set of client devices, indicative of activity associated with a content item of the one or more first content items within the one or more first time periods (when the one or more first content items are trending). Alternatively and/or additionally, each user profile of the first plurality of user profiles may comprise activity information, associated with a client device of the first set of client devices, indicative of activity associated with a content item of the one or more first content items within the one or more first time periods. For example, an exemplary user profile of the first plurality of user profiles may comprise exemplary activity information indicative of exemplary activity associated with an exemplary content item of the one or more first content items within the one or more first time periods (e.g., the exemplary activity associated with the exemplary content item of the one or more first content items may be performed within the one or more first time periods). The exemplary activity may correspond to one or more of the exemplary content item being consumed within the one or more first time periods, the exemplary content item being accessed within the one or more first time periods, the exemplary content item being selected within the one or more first time periods, the exemplary content item being interacted with within the one or more first time periods, etc.

A user profile of the second plurality of user profiles may comprise activity information, associated with a client device of the second set of client devices, indicative of activity associated with a content item of the one or more first content items within the one or more second time periods (when the one or more first content items are not trending). Alternatively and/or additionally, each user profile of the second plurality of user profiles may comprise activity information, associated with a client device of the second set of client devices, indicative of activity associated with a content item of the one or more first content items within the one or more second time periods. For example, an exemplary user profile of the second plurality of user profiles may comprise exemplary activity information indicative of exemplary activity associated with an exemplary content item of the one or more first content items within the one or more second time periods (e.g., the exemplary activity associated with the exemplary content item of the one or more first content items may be performed within the one or more second time periods). The exemplary activity may correspond to one or more of the exemplary content item being consumed within the one or more second time periods, the exemplary content item being accessed within the one or more second time periods, the exemplary content item being selected within the one or more second time periods, the exemplary content item being interacted with within the one or more second time periods, etc.

At 406, a first conversion score associated with a first entity may be determined based upon the first plurality of user profiles. In some examples, the first conversion score may be associated with a measure of conversion events associated with the first entity occurring after activity associated with the one or more first content items is performed within the one or more first time periods (when the one or more first content items are trending).

In some examples, the first entity may correspond to one or more of an advertiser, a company, an organization, etc. For example, a user associated with the first entity may access and/or interact with a service, such as an advertising service, that provides a platform for uploading, to the content system, content to be presented via client devices. One or more second content items (e.g., one or more advertisements) associated with the first entity, and/or associated with one or more products, one or more services, etc. associated with the first entity, may be received from a device associated with the first entity. For example, a device associated with the first entity may upload, to the content system, the one or more second content items. The one or more second content items may be associated with an advertisement campaign for promoting the one or more products and/or the one or more services associated with the first entity. Alternatively and/or additionally, content information associated with the advertisement campaign may be received from the device associated with the first entity. For example, the content information may comprise one or more of a budget (e.g., a daily budget) associated with the advertisement campaign, a duration of time for which the one or more second content items shall be presented by the content system, one or more advertisement campaign goals associated with the advertisement campaign and/or the one or more second content items (e.g., a number of impressions associated with the one or more second content items, a number of interactions associated with the one or more second content items, etc.), etc.

In some examples, a conversion event associated with the first entity may correspond to one or more of a purchase of a product of the one or more products associated with the first entity, a purchase of a service of the one or more services associated with the first entity, subscribing to (and/or signing up for) a service of the one or more services associated with the first entity, contacting the first entity (e.g., contacting the first entity via one or more of email, phone, etc.), a selection of a content item of the one or more second content items, an interaction with a content item of the one or more second content items, an impression associated with a content item of the one or more second content items, accessing a webpage associated with the first entity, etc.

Alternatively and/or additionally, the first entity may correspond to a type of product (e.g., cars, food, electronics, clothes, jewelry, content, articles, videos, blogs, etc.) and/or a type of service (e.g., repair services, catering services, home improvement services, internet services, etc.). In some examples, a conversion event associated with the first entity may correspond to one or more of a purchase of a product associated with the type of product (e.g., the type of product may be clothing and/or the product may be a shirt), a purchase of a service associated with the type of service, subscribing to (and/or signing up for) a service associated with the type of service, contacting a business, an organization, etc. associated with the type of product and/or the type of service (e.g., contacting a business, an organization, etc. that sells and/or manufactures one or more products associated with the type of product and/or that provides one or more services associated with the type of service), a selection of a content item associated with the type of product and/or the type of service, an interaction with a content item associated with the type of product and/or the type of service (e.g., the content item may be associated with an advertisement campaign for promoting one or more products and/or one or more services associated with the type of product and/or the type of service), an impression associated with a content item associated with the type of product and/or the type of service, accessing a webpage associated with one or more products and/or one or more services associated with the type of product and/or the type of service, etc.

Alternatively and/or additionally, the first entity may correspond to a subject (e.g., the subject may correspond to one or more entities, such as one or more places, one or more people, one or more things, etc. and/or the subject may correspond to one or more topics). In some examples, a conversion event associated with the first entity may correspond to one or more of a selection of a content item associated with the subject (e.g., one or more of selecting an article associated with the subject, selecting a video associated with the subject, etc.), an interaction with a content item associated with the subject, accessing a webpage associated with the subject (e.g., accessing a webpage comprising information associated with the subject), etc.

In some examples, the first plurality of user profiles may be analyzed to determine a first conversion rate, associated with the first entity, of the first set of client devices and/or the first set of user accounts. In some examples, the first plurality of user profiles may be analyzed to identify a first set of user profiles indicative of conversion events associated with the first entity. For example, a user profile of the first set of user profiles may be indicative of a conversion event associated with the first entity (and/or each user profile of the first set of user profiles may be indicative of a conversion event associated with the first entity). Alternatively and/or additionally, a user profile of the first set of user profiles may be indicative of a conversion event associated with the first entity performed after activity associated with a content item of the one or more first content items is performed (and/or each user profile of the first set of user profiles may be indicative of a conversion event associated with the first entity performed after activity associated with a content item of the one or more first content items is performed). In some examples, an exemplary user profile of the first plurality of user profiles may be determined to be in the first set of user profiles responsive to identifying first exemplary activity information indicative of first exemplary activity associated with an exemplary content item of the one or more first content items within the one or more first time periods and/or identifying second exemplary activity information indicative of second exemplary activity associated with performance of a conversion event associated with the first entity, where the second exemplary activity may be performed after the first exemplary activity.

In some examples, the first conversion rate associated with the first entity may be determined based upon a first quantity of user profiles of the first plurality of user profiles and/or a second quantity of user profiles of the first set of user profiles (associated with conversion events associated with the first entity). For example, the first conversion rate may correspond to one or more of a proportion, a percentage, etc. of user profiles of the first plurality of user profiles that are indicative of conversion events associated with the first entity.

In some examples, the first conversion score may correspond to the first conversion rate. Alternatively and/or additionally, the first conversion score may be based upon the first conversion rate and/or a second conversion rate. In some examples, the second conversion rate may correspond to one or more of a proportion, a percentage, etc. of user profiles of a third plurality of user profiles, of the user profile database, that are indicative of conversion events associated with the first entity. In some examples, the third plurality of user profiles may comprise the first plurality of user profiles, the second plurality of user profiles and/or other user profiles of the user profile database. In some examples, the second conversion rate may be determined based upon a third quantity of user profiles of the third plurality of user profiles and/or a fourth quantity of user profiles, of the third plurality of user profiles, indicative of conversion events associated with the first entity (e.g., the fourth quantity of user profiles may correspond to a quantity of user profiles of a set of user profiles, of the third plurality of user profiles, that are indicative of conversion events associated with the first entity).

In some examples, the first conversion score may be determined by performing one or more operations (e.g., mathematical operations) using the first conversion rate and/or the second conversion rate. Alternatively and/or additionally, the first conversion score may correspond to a relationship between the first conversion rate and the second conversion rate (e.g., one or more of a ratio, a proportion, a percentage, etc. associated with the first conversion rate and the second conversion rate). Alternatively and/or additionally, the first conversion score may correspond to a first conversion score category (e.g., positive) based upon the first conversion rate exceeding the second conversion rate and/or based upon the first conversion rate exceeding the second conversion rate by a first threshold difference. In some examples, the first conversion score category may be associated with user activity that may positively influence users to perform a conversion associated with the first entity. Alternatively and/or additionally, the first conversion score may correspond to a second conversion score category (e.g., negative) based upon the first conversion rate being less than the second conversion rate and/or based upon the first conversion rate being less than the second conversion rate by a second threshold difference. In some examples, the second conversion score category may be associated with user activity that may negatively influence users to perform a conversion associated with the first entity. Alternatively and/or additionally, the first conversion score may correspond to a third conversion score category (e.g., neutral) based upon a difference between the first conversion rate and the second conversion rate being less than a third threshold difference.

In some examples, a first lower confidence bound lcb(pₐ) associated with the first plurality of user profiles may be determined based upon the first conversion rate and/or the first quantity of user profiles of the first plurality of user profiles. Alternatively and/or additionally, a first upper confidence bound ucb(pₐ) associated with the first plurality of user profiles may be determined based upon the first conversion rate and/or the first quantity of user profiles of the first plurality of user profiles. Alternatively and/or additionally, a second lower confidence bound lcb(p₀) associated with the third plurality of user profiles may be determined based upon the second conversion rate and/or the third quantity of user profiles of the third plurality of user profiles. Alternatively and/or additionally, a second upper confidence bound ucb(p₀) associated with the second plurality of user profiles may be determined based upon the second conversion rate and/or the third quantity of user profiles of the third plurality of user profiles.

In some examples, a conversion score category corresponding to the first conversion score may be determined based upon the first lower confidence bound lcb(pₐ), the first upper confidence bound ucb(pₐ), the second lower confidence bound lcb(p₀) and/or the second upper confidence bound ucb(p₀). In some examples, the first conversion score may correspond to the first conversion score category (e.g., positive) based upon lcb(pₐ)>2ucb(p₀) being true. Alternatively and/or additionally, the first conversion score may correspond to the second conversion score category (e.g., negative) based upon ucb(pₐ)<1/2lcb(p₀) being true. Alternatively and/or additionally, the first conversion score may correspond to the third conversion score category (e.g., neutral) based upon lcb(pₐ)>2ucb(p₀) and/or ucb(pₐ)<1/2lcb(p₀) not being true.

In some examples, the first conversion score may be determined based upon a first duration of time of the one or more first time periods. In some examples, a higher duration of time of the one or more first time periods may correspond to a higher conversion score. Alternatively and/or additionally, the first duration of time may be compared with a threshold duration of time to determine whether the one or more first content items are associated with a long-term trend (e.g., a trend lasting one or more days and/or weeks) and/or a short-term trend (e.g., a trend lasting one or more hours and/or days). For example, responsive to a determination that the first duration of time exceeds the threshold duration of time, it may be determined that the one or more first content items are associated with a long-term trend. Alternatively and/or additionally, responsive to a determination that the first duration of time is less than the threshold duration of time, it may be determined that the one or more first content items are associated with a short-term trend. In a first example, the one or more first content items may be associated with a long-term trend and/or the first conversion score may correspond to a first exemplary value. In a second example, the one or more first content items may be associated with a short-term trend and/or the first conversion score may correspond to a second exemplary value. In some examples, the first exemplary value may be greater than the second exemplary value (and/or the first exemplary value may be less than the second exemplary value).

In some examples, the first conversion score may be associated with a first purchase funnel stage of a plurality of stages of a purchase funnel (e.g., a buying funnel, a sales funnel, a marketing funnel, etc.). For example, the purchase funnel may correspond to a staged process that a consumer may undergo when performing a conversion event, such as purchasing a product and/or a service. In some examples, the plurality of stages may comprise a first stage (e.g., “unaware”), a second stage (e.g., “aware”), a third stage (e.g., “interest”), a fourth stage (e.g., “consideration”), a fifth stage (e.g., “intent”) and/or a sixth stage (e.g., “purchase”). In some examples, each stage of the plurality of stages may be associated with a value (e.g., a numerical value) of a plurality of values (e.g., a plurality of numerical values). For example, the first stage may correspond to a first value (e.g., 0) of the plurality of values, the second stage may correspond to a second value (e.g., 1) of the plurality of values, the third stage may correspond to a third value (e.g., 2) of the plurality of values, the fourth stage may correspond to a fourth value (e.g., 3) of the plurality of values, the fifth stage may correspond to a fifth value (e.g., 4) of the plurality of values and/or the sixth stage may correspond to a sixth value (e.g., 5) of the plurality of values.

In some examples, the first purchase funnel stage may be determined based upon the first conversion score. Alternatively and/or additionally, the first purchase funnel stage may be determined based upon the first plurality of user profiles. For example, the first purchase funnel stage may be determined using one or more machine learning techniques, such as recurrent neural network techniques (and/or other artificial neural network techniques) (e.g., the recurrent neural network techniques may comprise attention-based techniques) using long short-term memory (LSTM) units and/or gated recurrent units (GRUs).

At 408, a second conversion score associated with the first entity may be determined based upon the second plurality of user profiles. In some examples, the second conversion score may be associated with a measure of conversion events associated with the first entity occurring after activity associated with the one or more first content items is performed within the one or more second time periods (when the one or more first content items are not trending).

In some examples, the second plurality of user profiles may be analyzed to determine a third conversion rate, associated with the first entity, of the second set of client devices and/or the second set of user accounts. In some examples, the second plurality of user profiles may be analyzed to identify a second set of user profiles indicative of conversion events associated with the first entity. For example, a user profile of the second set of user profiles may be indicative of a conversion event associated with the first entity (and/or each user profile of the second set of user profiles may be indicative of a conversion event associated with the first entity). Alternatively and/or additionally, a user profile of the second set of user profiles may be indicative of a conversion event associated with the first entity performed after activity associated with a content item of the one or more first content items is performed (and/or each user profile of the second set of user profiles may be indicative of a conversion event associated with the first entity performed after activity associated with a content item of the one or more first content items is performed). In some examples, an exemplary user profile of the second plurality of user profiles may be determined to be in the second set of user profiles responsive to identifying third exemplary activity information indicative of third exemplary activity associated with an exemplary content item of the one or more first content items within the one or more second time periods and/or identifying fourth exemplary activity information indicative of fourth exemplary activity associated with performance of a conversion event associated with the first entity, where the fourth exemplary activity may be performed after the third exemplary activity.

In some examples, the third conversion rate associated with the first entity may be determined based upon a fifth quantity of user profiles of the second plurality of user profiles and/or a sixth quantity of user profiles of the second set of user profiles (associated with conversion events associated with the first entity). For example, the third conversion rate may correspond to one or more of a proportion, a percentage, etc. of user profiles of the second plurality of user profiles that are indicative of conversion events associated with the first entity.

In some examples, the second conversion score may correspond to the third conversion rate. Alternatively and/or additionally, the first conversion score may be based upon the third conversion rate and/or the second conversion rate associated with the third plurality of user profiles of the user profile database.

In some examples, the second conversion score may be determined by performing one or more operations (e.g., mathematical operations) using the third conversion rate and/or the second conversion rate. Alternatively and/or additionally, the second conversion score may correspond to a relationship (e.g., one or more of a ratio, a proportion, a percentage, etc.) between the third conversion rate and the second conversion rate. Alternatively and/or additionally, the second conversion score may correspond to the first conversion score category (e.g., positive) based upon the third conversion rate exceeding the second conversion rate and/or based upon the third conversion rate exceeding the second conversion rate by the first threshold difference. Alternatively and/or additionally, the second conversion score may correspond to the second conversion score category (e.g., negative) based upon the third conversion rate being less than the second conversion rate and/or based upon the third conversion rate being less than the second conversion rate by the second threshold difference. Alternatively and/or additionally, the second conversion score may correspond to the third conversion score category (e.g., neutral) based upon a difference between the third conversion rate and the second conversion rate being less than the third threshold difference.

In some examples, a third lower confidence bound associated with the second plurality of user profiles may be determined based upon the third conversion rate and/or the fifth quantity of user profiles of the second plurality of user profiles. Alternatively and/or additionally, a third upper confidence bound associated with the second plurality of user profiles may be determined based upon the third conversion rate and/or the fifth quantity of user profiles of the second plurality of user profiles. In some examples, a conversion score category corresponding to the first conversion score may be determined using one or more of the techniques presented herein based upon the third lower confidence bound, the third upper confidence bound, the second lower confidence bound lcb(p₀) associated with the third plurality of user profiles and/or the second upper confidence bound ucb(p₀) associated with the third plurality of user profiles.

In some examples, the second conversion score may be associated with a second purchase funnel stage of the plurality of stages of the purchase funnel. In some examples, the second purchase funnel stage may be determined based upon the second conversion score. Alternatively and/or additionally, the second purchase funnel stage may be determined based upon the second plurality of user profiles. For example, the second purchase funnel stage may be determined using one or more machine learning techniques, such as recurrent neural network techniques (and/or other artificial neural network techniques) (e.g., the recurrent neural network techniques may comprise attention-based techniques) using LSTM units and/or GRUs.

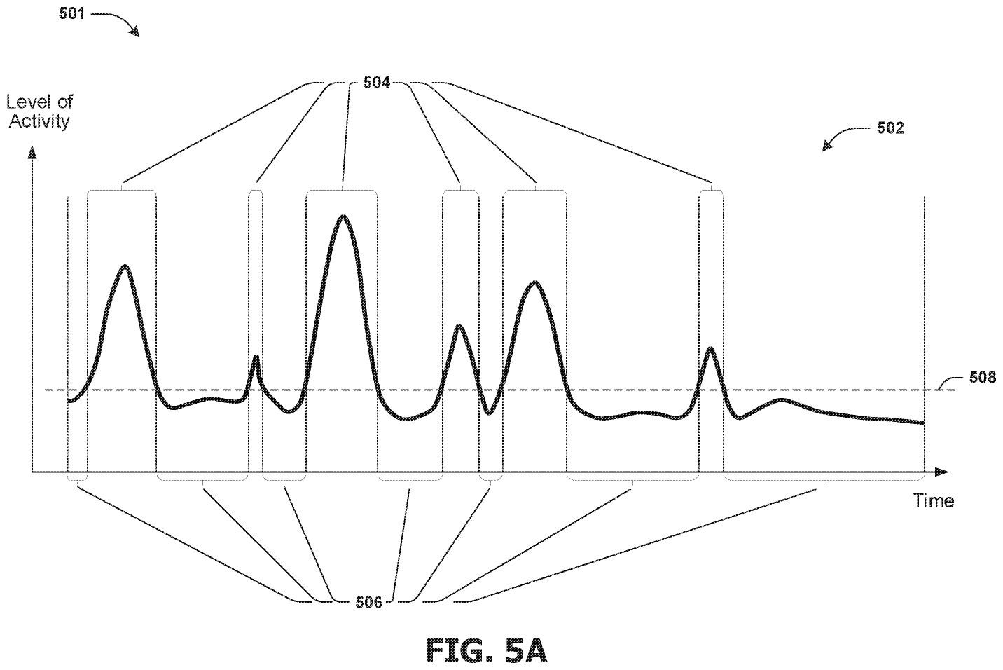

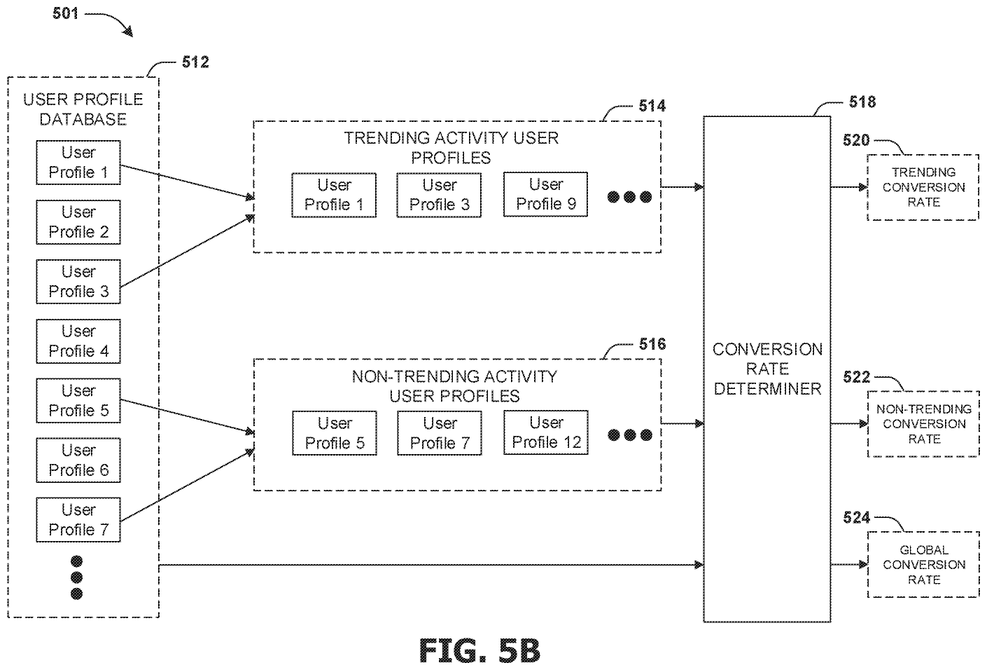

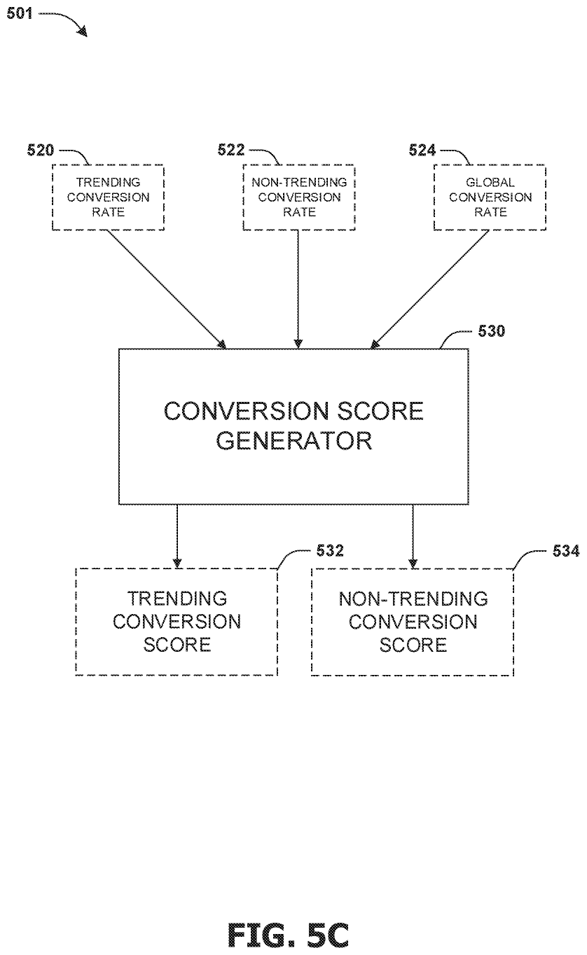

FIGS. 5A-5C illustrate an exemplary system 601 for determining one or more conversion scores associated with an entity. FIG. 5A illustrates an exemplary level of activity chart 502 illustrating an example of a level of activity curve corresponding to levels of activity associated with the one or more first content items, such as one or more of quantities of instances that the one or more first content items are consumed, quantities of instances that the one or more first content items are accessed, quantities of instances that the one or more first content items are presented via client devices, etc. over time. Alternatively and/or additionally, the level of activity curve may correspond to levels of activity associated with content items associated with the one or more first subjects, over time. Alternatively and/or additionally, the level of activity curve may correspond to levels of publishing activity associated with publication and/or generation of content items associated with the one or more first subjects, over time. Alternatively and/or additionally, the level of activity curve may correspond to levels of search activity associated with the one or more first keywords and/or the one or more first queries, over time.

In some examples, it may be determined that the one or more first content items are trending within a first set of time periods 504 (e.g., the one or more first time periods). For example, levels of activity associated with the one or more first content items may meet a threshold level of activity 508 during the first set of time periods 504. Alternatively and/or additionally, it may be determined that the one or more first content items are not trending within a second set of time periods 506 (e.g., the one or more second time periods). For example, levels of activity associated with the one or more first content items may not meet the threshold level of activity 508 during the second set of time periods 506.

FIG. 5B illustrates conversion rates being determined based upon an exemplary user profile database 512 (e.g., the user profile database). In some examples, the exemplary user profile database 512 may comprise an exemplary plurality of user profiles. The exemplary user profile database 512 may be analyzed based upon the one or more first content items, the first set of time periods 504 and/or the second set of time periods 506 to identify a plurality of trending activity user profiles 514 (e.g., the first plurality of user profiles) and/or a plurality of non-trending activity user profiles 516 (e.g., the second plurality of user profiles). In some examples, the plurality of trending activity user profiles 514 may comprise user profiles indicative of activity associated with the one or more first content items within the first set of time periods 504 (when the one or more first content items are trending). Alternatively and/or additionally, the plurality of non-trending activity user profiles 516 may comprise user profiles indicative of activity associated with the one or more first content items within the second set of time periods 506 (when the one or more first content items are not trending).

In some examples, a trending conversion rate 520 (e.g., the first conversion rate) may be determined by a conversion rate determiner 518 based upon the plurality of trending activity user profiles 514. For example, the trending conversion rate 520 may correspond to one or more of a proportion, a percentage, etc. of user profiles of the plurality of trending activity user profiles 514 that are indicative of conversion events associated with the first entity.

Alternatively and/or additionally, a non-trending conversion rate 522 (e.g., the third conversion rate) may be determined by the conversion rate determiner 518 based upon the plurality of non-trending activity user profiles 516. For example, the non-trending conversion rate 522 may correspond to one or more of a proportion, a percentage, etc. of user profiles of the plurality of non-trending activity user profiles 516 that are indicative of conversion events associated with the first entity.

Alternatively and/or additionally, a global conversion rate 524 (e.g., the third conversion rate) may be determined by the conversion rate determiner 518 based upon the exemplary plurality of user profiles of the exemplary user profile database 512. For example, the global conversion rate 524 may correspond to one or more of a proportion, a percentage, etc. of user profiles of the exemplary plurality of user profiles that are indicative of conversion events associated with the first entity.

FIG. 5C illustrates conversion scores being determined based upon conversion rates. For example, a trending conversion score 532 (e.g., the first conversion score) may be generated by a conversion score generator 530 based upon the trending conversion rate 520 and/or the global conversion rate 524. Alternatively and/or additionally, a non-trending conversion score 534 (e.g., the second conversion score) may be generated by the conversion score generator 530 based upon the non-trending conversion rate 522 and/or the global conversion rate 524.

In some examples, a first plurality of sets of conversion scores associated with the one or more first content items may be generated using one or more of the techniques presented herein. For example, a set of conversion scores of the first plurality of sets of conversion scores may comprise a trending conversion score (such as the first conversion score associated with the first plurality of user profiles) and/or a non-trending conversion score (such as the second conversion score associated with the second plurality of user profiles). In some examples, a trending conversion score may correspond to a conversion score associated with one or more content items that is determined based upon user profiles indicative of activity associated with the one or more content items when the one or more content items are trending. Alternatively and/or additionally, a non-trending conversion score may correspond to a conversion score associated with one or more content items that is determined based upon user profiles indicative of activity associated with the one or more content items when the one or more content items are not trending. In some examples, the first plurality of sets of conversion scores may be associated with a plurality of entities. For example, a set of conversion scores of the first plurality of sets of conversion scores may be associated with an entity of the plurality of entities (and/or each set of conversion scores of the first plurality of sets of conversion scores may be associated with an entity of the plurality of entities).

In an example, a first set of conversion scores of the first plurality of sets of conversion scores may comprise the first conversion score and/or the second conversion score associated with the first entity. A second set of conversion scores of the first plurality of sets of conversion scores may comprise a third conversion score (e.g., a trending conversion score) and/or a fourth conversion score (e.g., a non-trending conversion score) associated with a second entity. For example, the third conversion score may be associated with a measure of conversion events associated with the second entity occurring after activity associated with the one or more first content items is performed within the one or more first time periods (when the one or more first content items are trending). The third conversion score may be determined based upon a conversion rate, of the first plurality of user profiles, associated with the second entity (e.g., the third conversion score may be determined based upon one or more of a proportion, a percentage, etc. of user profiles of the first plurality of user profiles that are indicative of conversion events associated with the second entity). Alternatively and/or additionally, the fourth conversion score may be associated with a measure of conversion events associated with the second entity occurring after activity associated with the one or more first content items is performed within the one or more second time periods (when the one or more first content items are not trending). The fourth conversion score may be determined based upon a conversion rate, of the second plurality of user profiles, associated with the second entity (e.g., the fourth conversion score may be determined based upon one or more of a proportion, a percentage, etc. of user profiles of the second plurality of user profiles that are indicative of conversion events associated with the second entity).

In some examples, a content items database associated with the content system may comprise the first plurality of sets of conversion scores associated with the one or more first content items. The content items database may comprise a plurality of content items. A set of content items (e.g., a set of one or more content items, such as the one or more first content items) of the plurality of content items may be associated with a plurality of sets of conversion scores (and/or each content item of the plurality of content items may be associated with a plurality of sets of conversion scores). For example, the content items database may comprise a second plurality of sets of conversion scores associated with one or more second content items of the plurality of content items (where a set of conversion scores of the second plurality of sets of conversion scores may be associated with an entity of the plurality of entities), a third plurality of sets of conversion scores associated with one or more third content items of the plurality of content items (where a set of conversion scores of the third plurality of sets of conversion scores may be associated with an entity of the plurality of entities), etc.

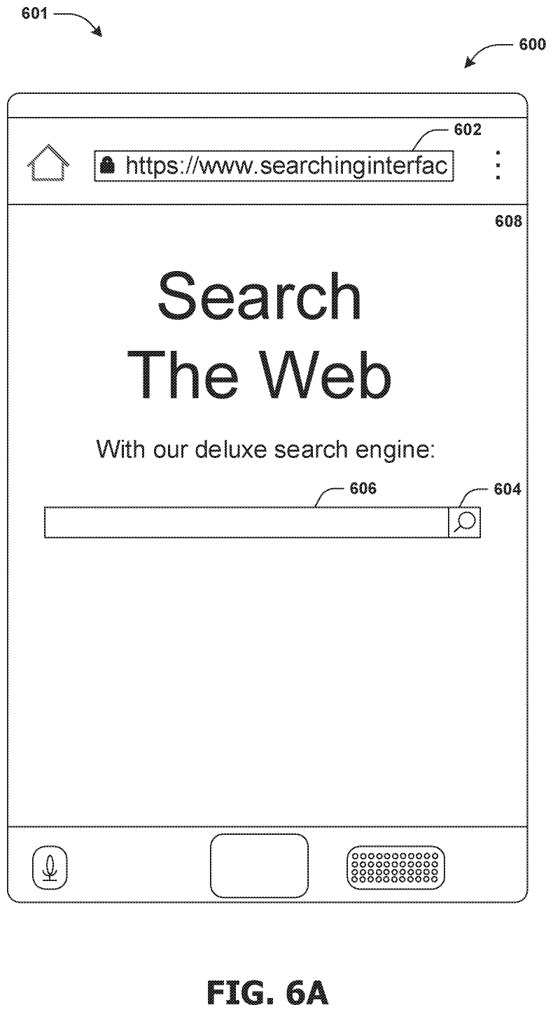

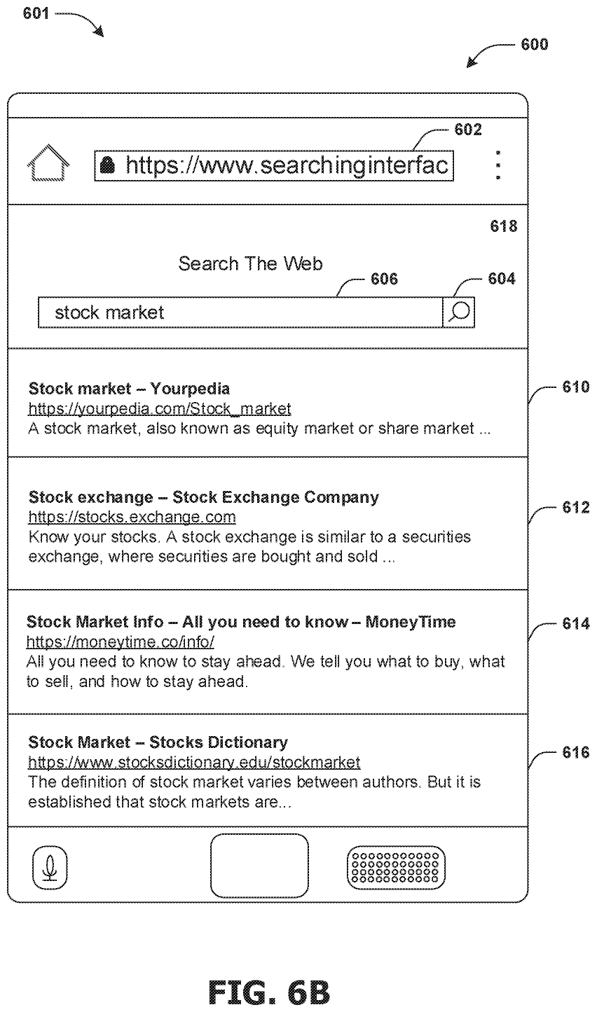

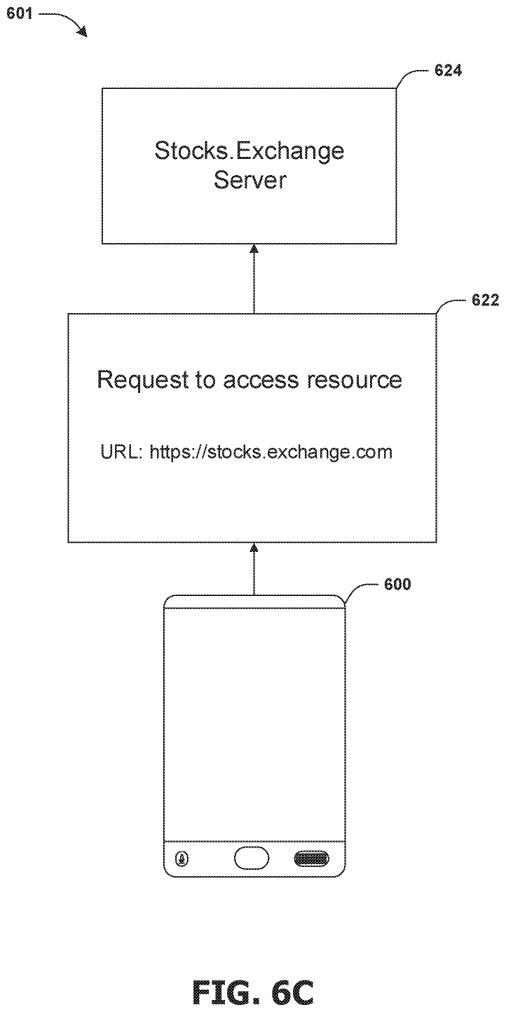

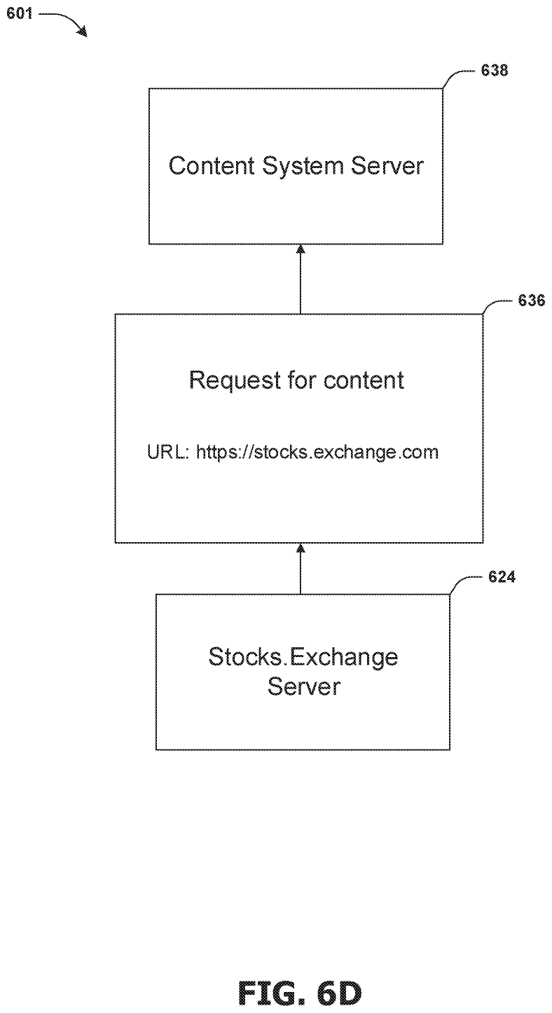

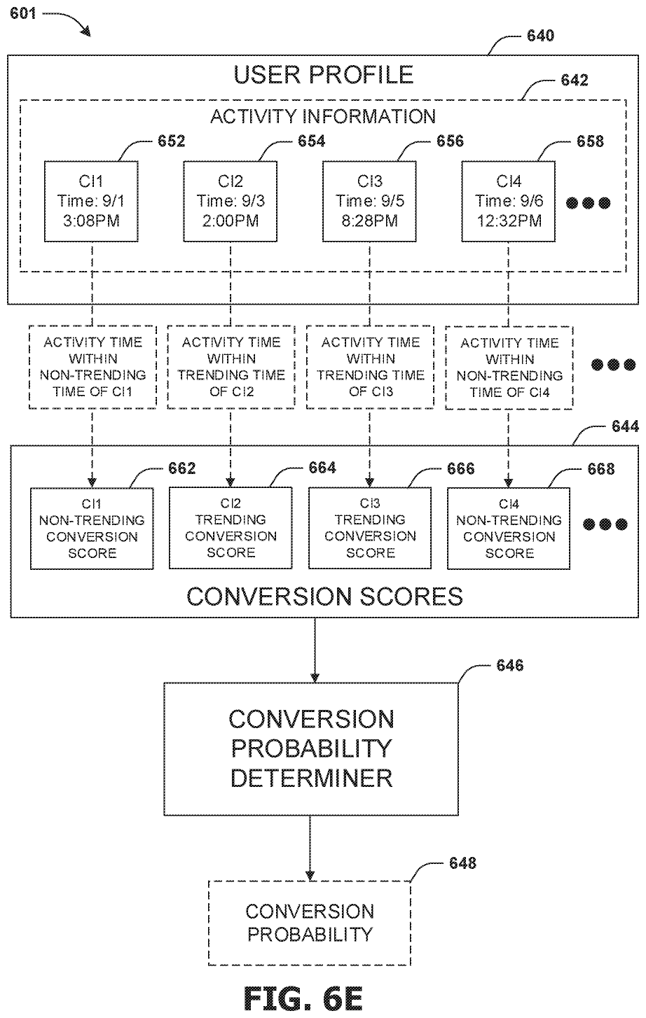

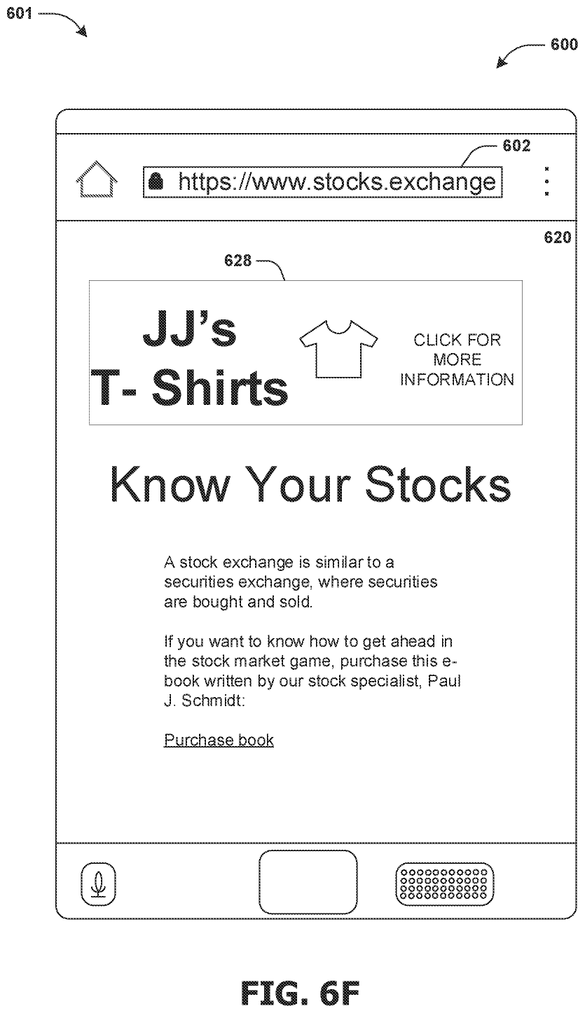

At 410, a request for content (e.g., a request for content 636 illustrated in FIG. 6D) associated with a first client device (e.g., a first client device 600 illustrated in FIG. 6A) may be received. In some examples, the request for content may be received from the first client device in association with a request to access a web page and/or a request to access one or more resources (e.g., one or more resources of an application (e.g., a mobile application)). Alternatively and/or additionally, the request for content may be received from a server associated with the web page and/or the one or more resources (as shown in FIGS. 6A-6D).

In some examples, the request for content may correspond to a request to provide a content item (e.g., one or more of an article, a video, an audio file, an image, a webpage, an advertisement, an email, a message, etc.) for presentation via the web page and/or the one or more resources while the web page and/or the one or more resources are accessed by the first client device. In some examples, responsive to receiving the request for content, an exemplary content item may be selected for presentation via the first client device. Alternatively and/or additionally, the exemplary content item may be presented via the web page and/or the one or more resources. For example, the exemplary content item may be presented one or more of at the top of the web page (e.g., within a banner area), at the side of the web page (e.g., within a column), in a pop-up window, overlaying content of the web page, etc. In some examples, the exemplary content item may be an advertisement. Alternatively and/or additionally, the exemplary content item may not be an advertisement.

FIGS. 6A-6F illustrate an exemplary system 601 for selecting content for transmission to client devices. A first user, such as user Jill, and/or a first client device 600 associated with the first user, may access and/or interact with a service, such as a browser, software, a website, an application, an operating system, an email interface, a messaging interface, a music-streaming application, a video application, etc. that provides a platform for viewing and/or downloading content from a server associated with the content system. In some examples, the user profile database may comprise a first user profile. The first user profile may be associated with the first client device 600 and/or the first user profile may be associated with a first user account associated with the first client device 600. In some examples, the content system may use user information comprised within the first user profile, such as one or more of activity information, demographic information associated with the first user, location information, etc. to determine interests of the first user and/or select content for presentation to the first user based upon the interests of the first user.

FIG. 6A illustrates the first client device 600 presenting and/or accessing a first web page 608 using a browser of the first client device 600. The browser may comprise an address bar 602 comprising a web address (e.g., a URL) of the first web page 608. The first web page 608 may comprise a search interface. For example, the search interface may comprise a web search engine designed to search for information throughout the internet. In some examples, the first web page 608 may comprise a search field 606. For example, a query “stock market” may be entered into the search field 606. In some examples, the first web page 608 may comprise a search selectable input 604 corresponding to performing a search based upon the query. For example, the search selectable input 604 may be selected.

FIG. 6B illustrates the first client device 600 presenting a plurality of search results associated with the query using the browser of the first client device 600. For example, the plurality of search results may be presented within a second web page 618. For example, the plurality of search results may comprise a first search result 610 corresponding to a third web page, a second search result 612 corresponding to a fourth web page 620 (illustrated in FIG. 6F), a third search result 614 corresponding to a fifth web page and/or a fourth search result 616 corresponding to a sixth web page.

In some examples, each search result of the plurality of search results may comprise a selectable input (e.g., a link) corresponding to accessing a web page associated with the search result. In some examples, the second search result 612 corresponding to the fourth web page 620 may be selected (e.g., the second search result 612 may be selected via a second selectable input corresponding to the second search result 612).

FIG. 6C illustrates the first client device 600 transmitting a request to access a resource 622 to a first server 624. In some examples, the request to access the resource 622 may be transmitted responsive to the second search result 612 being selected. For example, the resource may correspond to the fourth web page 620. For example, the request to access the resource 622 may comprise an indication of the fourth web page 620 (e.g., a web address “https://stocks.exchange.com”). Alternatively and/or additionally, the first server 624 may be associated with the fourth web page 620.

FIG. 6D illustrates the first server 624 transmitting a request for content 636 to a second server 638 associated with the content system. In some examples, the request for content 636 may be transmitted (by the first server 624) responsive to receiving the request to access the resource 622. Alternatively and/or additionally, the request for content 636 may be transmitted (to the second server 638) by the first client device 600. In some examples, the request for content 636 may be a request to be provided with a transmission content item (e.g., an advertisement, an image, a link, a video, etc.) (for presentation via the fourth web page 620).

At 412, the user profile database may be analyzed to identify the first user profile (e.g., a first user profile 640 illustrated in FIG. 6E) associated with the first client device 600. The first user profile may comprise first activity information (e.g., first activity information 642 illustrated in FIG. 6E) associated with the first client device 600. In some examples, the first activity information may be indicative of a second plurality of content items. For example, the second plurality of content items may comprise one or more of one or emails, one or more messages, one or more articles, one or more videos, one or more audio files, one or more images, one or more web pages, one or more advertisements, etc. In some examples, the first activity information may be indicative of one or more of one or more content items of the second plurality of content items being opened, one or more content items being accessed, one or more content items of the second plurality of content items being selected, one or more content items of the second plurality of content items being shared, one or more content items of the second plurality of content items being presented (via the first client device 600), one or more content items of the second plurality of content items being interacted with, one or more content items of the second plurality of content items being consumed, etc.

Alternatively and/or additionally, the first activity information may comprise a plurality of sets of activity information associated with the first client device 600 and/or the first user account. For example, a set of activity information of the plurality of sets of activity information may comprise an indication of a consumed content item (e.g., an email, a message, an article, a video, an audio file, an image, a webpage, an advertisement, etc. consumed by the first user), an accessed content item (e.g., an email, a message, an article, a video, an audio file, an image, a webpage, an advertisement, etc. accessed by the first client device 600), a selected content item (e.g., an email, a message, an article, a video, an audio file, an image, a webpage, an advertisement, etc. selected via the first client device 600), a composed email, a composed message, a query used to perform a search, etc.

Alternatively and/or additionally, the first activity information may comprise time-related information associated with the plurality of sets of activity information. For example, the activity profile may comprise a plurality of time indications (e.g., timestamps) associated with the plurality of sets of activity information. For example, each time indication of the plurality of time indications may correspond to a set of activity information of the plurality of sets of activity information. In an example, a first set of activity information of the plurality of sets of activity information may correspond to a first web page accessed using the first client device 600 (and/or a different client device). A first time indication, corresponding to the first set of activity information, may comprise a time that the first web page is accessed by the first client device 600.

At 414, responsive to determining that the first activity information is indicative of first activity associated with an exemplary content item of the one or more first content items, a first conversion probability (e.g., a first conversion probability 648 illustrated in FIG. 6E) associated with the first client device 600 and/or the first user account may be determined based upon the first conversion score and/or the second conversion score (and/or based upon one or more conversion scores different than the first conversion score and/or the second conversion score).

The first conversion probability may correspond to a probability that a conversion event associated with the first entity is performed via the first client device 600. For example, the first conversion probability may correspond to a probability that the first user purchases a product associated with the first entity. Alternatively and/or additionally, the first conversion probability may correspond to a probability that the first user purchases a service associated with the first entity. Alternatively and/or additionally, the first conversion probability may correspond to a probability that the first user subscribes to (and/or signs up for) a service associated with the first entity. Alternatively and/or additionally, the first conversion probability may correspond to a probability that the first user contacts an organization, a business, a company, etc. associated with the first entity (e.g., via one or more of email, phone, etc.). Alternatively and/or additionally, the first conversion probability may correspond to a probability that the first user selects a content item associated with the first entity (e.g., the first conversion probability may correspond to a probability of receiving a selection of a content item associated with the first entity responsive to presenting the content item via the first client device 600). Alternatively and/or additionally, the first conversion probability may correspond to a probability that the first user interacts with and/or consumes a content item associated with the first entity (e.g., the first conversion probability may correspond to a probability of receiving a signal indicative of an interaction with a content item associated with the first entity and/or an impression associated with the content item responsive to presenting the content item via the first client device 600). Alternatively and/or additionally, the first conversion probability may correspond to a probability that the first user accesses a webpage associated with the first entity.

In some examples, the first conversion probability may be determined based upon the first conversion score responsive to (and/or based upon) a determination that the first activity associated with the exemplary content item of the one or more first content items is performed at a time that the one or more first content items are trending. For example, the first activity may correspond to the exemplary content item of the one or more first content items being one or more of opened, accessed, selected, shared, presented, interacted with, consumed, etc. at a time that the one or more first content items are trending (such as within the one or more first time periods).

In some examples, the first conversion probability may be determined based upon the second conversion score responsive to (and/or based upon) a determination that the first activity associated with the exemplary content item of the one or more first content items is performed at a time that the one or more first content items are not trending. For example, the first activity may correspond to the exemplary content item of the one or more first content items being one or more of opened, accessed, selected, shared, presented, interacted with, consumed, etc. at a time that the one or more first content items are not trending (such as within the one or more second time periods).

In some examples, the first conversion probability may be determined based upon a plurality of conversion scores (e.g., a plurality of conversion scores 644 illustrated in FIG. 6E) associated with the first entity. The plurality of conversion scores may be determined based upon the plurality of sets of activity information of the first user profile. For example, a first set of activity information of the plurality of sets of activity information may be indicative of the exemplary content item of the one or more first content items, the first activity associated with the exemplary content item of the one or more first content items and/or a first time indication indicative of the time at which the first activity associated with the exemplary content item of the one or more first content items is performed. In some examples, the first conversion score associated with the one or more first content items may be selected for inclusion in the plurality of conversion scores based upon a determination that the first time indication associated with the first activity corresponds to a time that the one or more first content items are trending. Alternatively and/or additionally, the second conversion score associated with the one or more first content items may be selected for inclusion in the plurality of conversion scores based upon a determination that the first time indication associated with the first activity corresponds to a time that the one or more first content items are not trending.

Alternatively and/or additionally, a second set of activity information of the plurality of sets of activity information may be indicative of a second exemplary content item, second activity associated with the second exemplary content item and/or a second time indication indicative of a time at which the second activity associated with the second exemplary content item is performed. The second exemplary content item may be associated with an exemplary set of conversion scores of the first plurality of sets of conversion scores. For example, the exemplary set of conversion scores may comprise an exemplary trending conversion score and/or an exemplary non-trending conversion score. The exemplary trending conversion score may be determined based upon user profiles indicative of activity associated with the second exemplary content item performed at times that the second exemplary content item is trending. Alternatively and/or additionally, the exemplary non-trending conversion score may be determined based upon user profiles indicative of activity associated with the second exemplary content item performed at times that the second exemplary content item is not trending. In some examples, the exemplary trending conversion score associated with the second exemplary content item may be selected for inclusion in the plurality of conversion scores based upon a determination that the second time indication associated with the second activity corresponds to a time that the second exemplary content item is trending. Alternatively and/or additionally, the exemplary non-trending conversion score associated with the second exemplary content item may be selected for inclusion in the plurality of conversion scores based upon a determination that the second time indication associated with the second activity corresponds to a time that the second exemplary content item is not trending.

FIG. 6E illustrates a first conversion probability 648 being determined based upon a first user profile 640 associated with the first client device 600 and/or the first user account. For example, the first user profile 640 may comprise first activity information 642. The first activity information 642 may comprise a first exemplary set of activity information 652 indicative of activity associated with a first exemplary content item CI1 and/or a first time indication indicative of a time at which the activity associated with the first exemplary content item CI1 is performed (e.g., Day: 09/01, Time of day: 3:08 PM). Alternatively and/or additionally, the first activity information 642 may comprise a second exemplary set of activity information 654 indicative of activity associated with a second exemplary content item CI2 and/or a second time indication indicative of a time at which the activity associated with the second exemplary content item CI2 is performed (e.g., Day: 09/03, Time of day: 2:00 PM). Alternatively and/or additionally, the first activity information 642 may comprise a third exemplary set of activity information 656 indicative of activity associated with a third exemplary content item CI3 and/or a third time indication indicative of a time at which the activity associated with the third exemplary content item CI3 is performed (e.g., Day: 09/05, Time of day: 8:28 PM). Alternatively and/or additionally, the first activity information 642 may comprise a fourth exemplary set of activity information 658 indicative of activity associated with a fourth exemplary content item CI4 and/or a fourth time indication indicative of a time at which the activity associated with the fourth exemplary content item CI4 is performed (e.g., Day: 09/06, Time of day: 12:32 PM).

In some examples, a plurality of conversion scores 644 associated with the first activity information 642 may be determined. In some examples, the first exemplary content item CI1 may be associated with a first exemplary trending conversion score and/or a first exemplary non-trending conversion score 662. In some examples, the first exemplary non-trending conversion score 662 may be selected for inclusion in the plurality of conversion scores 644 based upon a determination that the first time indication corresponds to a time when the first exemplary content item CI1 is not trending.

Alternatively and/or additionally, the second exemplary content item CI2 may be associated with a second exemplary trending conversion score 664 and/or a second exemplary non-trending conversion score. In some examples, the second exemplary trending conversion score 664 may be selected for inclusion in the plurality of conversion scores 644 based upon a determination that the second time indication corresponds to a time when the second exemplary content item CI2 is trending.

Alternatively and/or additionally, the third exemplary content item CI3 may be associated with a third exemplary trending conversion score 666 and/or a third exemplary non-trending conversion score. In some examples, the third exemplary trending conversion score 666 may be selected for inclusion in the plurality of conversion scores 644 based upon a determination that the third time indication corresponds to a time when the third exemplary content item CI3 is trending.

Alternatively and/or additionally, the fourth exemplary content item CI4 may be associated with a fourth exemplary trending conversion score and/or a fourth exemplary non-trending conversion score 668. In some examples, the fourth exemplary non-trending conversion score 668 may be selected for inclusion in the plurality of conversion scores 644 based upon a determination that the fourth time indication corresponds to a time when the fourth exemplary content item CI4 is not trending.

In some examples, a conversion probability determiner 646 may determine the first conversion probability 648 associated with the first entity based upon the plurality of conversion scores 644. For example, the conversion probability determiner 646 may perform one or more operations (e.g., mathematical operations) using the plurality of conversion scores 644 to determine the first conversion probability 648.

At 416, a first transmission content item may be selected for transmission to the first client device 600 based upon the first conversion probability 648. Alternatively and/or additionally, a plurality of conversion probabilities, comprising the first conversion probability, may be determined using one or more of the techniques presented herein. For example, a conversion probability of the plurality of conversion probabilities may be associated with an entity of the plurality of entities. Alternatively and/or additionally, each conversion probability of the plurality of conversion probabilities may be associated with an entity of the plurality of entities.

For example, the plurality of conversion probabilities may be analyzed to determine a highest conversion probability, of the plurality of conversion probabilities, associated with an exemplary entity. The first transmission content item may be selected from a plurality of transmission content items of the content items database based upon a determination that the first transmission content item is associated with the exemplary entity associated with the highest conversion probability of the plurality of conversion probabilities.

Alternatively and/or additionally, the first transmission content item may be selected from the plurality of transmission content items based upon the plurality of conversion probabilities and/or a plurality of bid values associated with the plurality of transmission content items. For example, a bid value of the plurality of bid values may be associated with a content item of the plurality of transmission content items. In some examples, the plurality of bid values may be determined based upon budgets (e.g., daily budgets) and/or target spend patterns associated with the plurality of transmission content items.

In some examples, a plurality of content item scores associated with the plurality of transmission content items may be determined based upon the plurality of conversion probabilities and/or the plurality of bid values. For example, a content item score of the plurality of content item scores may be associated with a content item of the plurality of transmission content items. In some examples, one or more operations (e.g., mathematical operations) may be performed using a conversion probability associated with a content item (e.g., the conversion probability may be associated with an entity associated with the content item) and/or a bid value associated with the content item to determine a content item score associated with the content item. In some examples, the first transmission content item may be selected from the plurality of transmission content items based upon the plurality of content item scores (e.g., the first transmission content item may be selected based upon a determination that a content item score associated with the first transmission content item is a highest content item score of the plurality of content item scores).

At 418, the transmission content item may be transmitted to the first client device 600. FIG. 6F illustrates the first client device 600 presenting and/or accessing the fourth web page 620 using the browser of the first client device 600. For example, the content system may provide a content item 628 (e.g., the transmission content item) to be presented via the fourth web page 620 while the fourth web page 620 is accessed by the first client device 600.

In an example, the one or more first content items may correspond to content items (e.g., articles, videos, news articles, etc.) associated with fashion. Alternatively and/or additionally, the first entity may correspond to clothing products (e.g., a conversion event associated with the first entity may correspond to one or more of a selection of a content item such as an advertisement associated with clothing products, a purchase of a clothing product, etc.). It may be determined based upon the first plurality of user profiles that users that consume the one or more first content items when the one or more first content items are trending are associated with a greater than average rate of performing conversion events associated with the first entity. For example, the first conversion rate associated with the first entity (e.g., clothing products) determined based upon the first plurality of user profiles may be greater than the second conversion rate associated with the first entity determined based upon the user profile database. Accordingly, transmission content items associated with the first entity (e.g., clothing products) may be selected for transmission to client devices associated with accessing the one or more first content items when the one or more first content items are trending. Alternatively and/or additionally, transmission content items associated with the first entity may be selected for transmission to client devices associated with accessing trending content items associated with fashion that are different than the one or more first content items.

In some examples, a summary report may be generated based upon the first conversion score, the second conversion score, the one or more first content items, the first plurality of user profiles and/or the second plurality of user profiles. In some examples, the summary report may be indicative of the first conversion score, the second conversion score, the one or more first content items, the first plurality of user profiles and/or the second plurality of user profiles. Alternatively and/or additionally, the summary report may be transmitted to a client device associated with the first entity. In an example where the first entity corresponds to an advertiser and/or a company, the summary report may be transmitted to a client device associated with the advertiser and/or the company. In an example where the first entity corresponds to a type of product and/or a type of service, the summary report may be transmitted to a client device associated with an advertiser, a company, a manufacturer, etc. that is associated with the type of product and/or the type of service (e.g., the summary report may be transmitted to a client device associated with an advertiser that advertises products associated with the type of product).

In some examples, the first conversion score, the first conversion rate and/or the second conversion rate may be analyzed to determine a first probability of users performing a conversion event associated with the first entity after consuming the one or more first content items when the one or more first content items are trending and/or after consuming one or more other content items associated with the one or more first subjects when the one or more other content items are trending. Alternatively and/or additionally, the second conversion score, the third conversion rate and/or the second conversion rate may be analyzed to determine a second probability of users performing a conversion event associated with the first entity after consuming the one or more first content items when the one or more first content items are not trending and/or after consuming one or more other content items associated with the one or more first subjects when the one or more other content items are not trending.

Alternatively and/or additionally, a plurality of conversion scores (comprising the first conversion score and/or the second conversion score) associated with the first entity may be determined based upon the user profile database. The plurality of conversion scores may be associated with a plurality of content items (comprising the one or more first content items). For example, the plurality of conversion scores may comprise a trending conversion score associated with one or more exemplary content items of the plurality of content items and/or a non-trending conversion score associated with the one or more exemplary content items of the plurality of content items. Alternatively and/or additionally, the plurality of conversion scores may be associated with a plurality of subjects (comprising the one or more first subjects). For example, the plurality of conversion scores may comprise a trending conversion score associated with content items associated with one or more second subjects and/or a non-trending conversion score associated with content items associated with the one or more second subjects.

The plurality of conversion scores may be analyzed to determine a plurality of probabilities. A first exemplary probability of the plurality of probabilities corresponds to a probability of users performing a conversion event associated with the first entity after consuming an exemplary content item of the plurality of content items when the exemplary content item is trending. Alternatively and/or additionally, a second exemplary probability of the plurality of probabilities corresponds to a probability of users performing a conversion event associated with the first entity after consuming the exemplary content item when the exemplary content item is not trending. One or more highest probabilities of the plurality of probabilities may be determined. One or more content items and/or one or more subjects associated with the one or more highest probabilities may be determined and/or one or more trending statuses may be determined (e.g., a trending status may correspond to whether a probability of the one or more highest probabilities is associated with trending activity and/or non-trending activity). In some examples, the summary report may be indicative of the plurality of conversion scores, a plurality of conversion score categories associated with the plurality of conversion scores, the plurality of probabilities, the one or more highest probabilities, the one or more content items, the one or more subjects and/or the one or more trending statuses of the one or more highest probabilities. In an example, the summary report may comprise “Users who consumed trending celebrity news articles are most likely to click on your advertisements. Users who consumed celebrity news articles that are not trending are likely to click on your advertisements, but not as likely as those users that consumed trending celebrity news articles. Also, users who consumed articles about shoes that are not trending are also likely to click on your advertisements”.

In some examples, a change in quantity of conversion events associated with dedicating a portion of a budget of an advertisement campaign to transmit content items to client devices associated with users that have consumed one or more content items may be determined. For example, a first change in quantity of conversion events may correspond to a change in quantity of conversion events associated with dedicating a first portion of the budget of the advertisement campaign to transmit content items (e.g., advertisements) to client devices associated with users that have consumed the one or more first content items while the one or more first content items were trending and/or have consumed one or more other content items associated with the one or more first subjects while the one or more other content items were trending. The first change in quantity of conversion events may be determined based upon a current rate at which conversion events associated with the first entity are performed, the first probability and/or other probabilities of the plurality of probabilities. The summary report may comprise the first change in quantity of conversion events. In an example, the summary report may comprise: “If 30% of the advertisement campaign's budget is dedicated towards showing advertisements to users that have consumed trending celebrity news articles, the conversion event rate may increase by about 15%”.

In some examples, the user profile database may be analyzed to identify a plurality of trending content items. The plurality of trending content items may be analyzed to identify types of content items of the plurality of trending content items. For example, it may be determined that a first portion of the plurality of trending content items is associated with a first type of content item (e.g., the first portion of the plurality of trending content items comprises videos), a second portion of the plurality of trending content items is associated with a second type of content item (e.g., the second portion of the plurality of trending content items comprises images), etc. One or more types of content items associated with the plurality of trending content items may be included in the summary report. Alternatively and/or additionally, a proportion of the plurality of trending content items associated a type of content item of the one or more types of content items may be included in the summary report (e.g., the summary report may comprise “60% of trending content are videos”). Alternatively and/or additionally, a preferred type of content item associated with over a threshold proportion of the plurality of trending content items may be determined. A content item (e.g., an advertisement) may be selected for transmission to a client device based upon a determination that the content item is associated with the preferred type of content item.

It may be appreciated that the disclosed subject matter may assist a user (and/or a client device associated with the user) in viewing and/or consuming content associated with subject matter that the user has an interest in.

Implementation of at least some of the disclosed subject matter may lead to benefits including, but not limited to, automatic determination of trending conversion scores and non-trending conversion scores associated with content items and automatic determination of conversion probabilities associated with client devices based upon activity with the content items, such that a content item that a user associated with a client device may be interested in may be selected for transmission to the client device based upon a conversion probability associated with the user.

Alternatively and/or additionally, implementation of at least some of the disclosed subject matter may lead to benefits including a reduction in screen space and/or an improved usability of a display (e.g., of the client device) (e.g., as a result of enabling the user to automatically consume content associated with subject matter that the user has an interest in, wherein the user may not view content that the user does not have an interest in, wherein the user may not need to open a separate application and/or a separate window in order to find content having the subject matter that the user has an interest in, etc.).

Alternatively and/or additionally, implementation of at least some of the disclosed subject matter may lead to benefits including a reduction in bandwidth (e.g., as a result of reducing a need for the user to open a separate application and/or a separate window in order to search throughout the internet and/or navigate through internet content to find content that the user has an interest in).

Alternatively and/or additionally, implementation of at least some of the disclosed subject matter may lead to benefits including more accurate and precise transmission of content to intended users (e.g., as a result of automatically determining conversion probabilities associated with users, as a result of transmitting content to each user based upon the conversion probabilities, etc.).

Alternatively and/or additionally, implementation of at least some of the disclosed subject matter may lead to benefits including a faster identification of content to be transmitted and/or faster loading of the content on a receiving device. For example, by using user profiles, conversion scores and/or conversion probabilities as provided for herein, accurate content can be identified at an increased speed, and thus delay between receiving a request for content and transmission of the content and/or displaying of the content can be reduced.

In some examples, at least some of the disclosed subject matter may be implemented on a client device, and in some examples, at least some of the disclosed subject matter may be implemented on a server (e.g., hosting a service accessible via a network, such as the Internet).

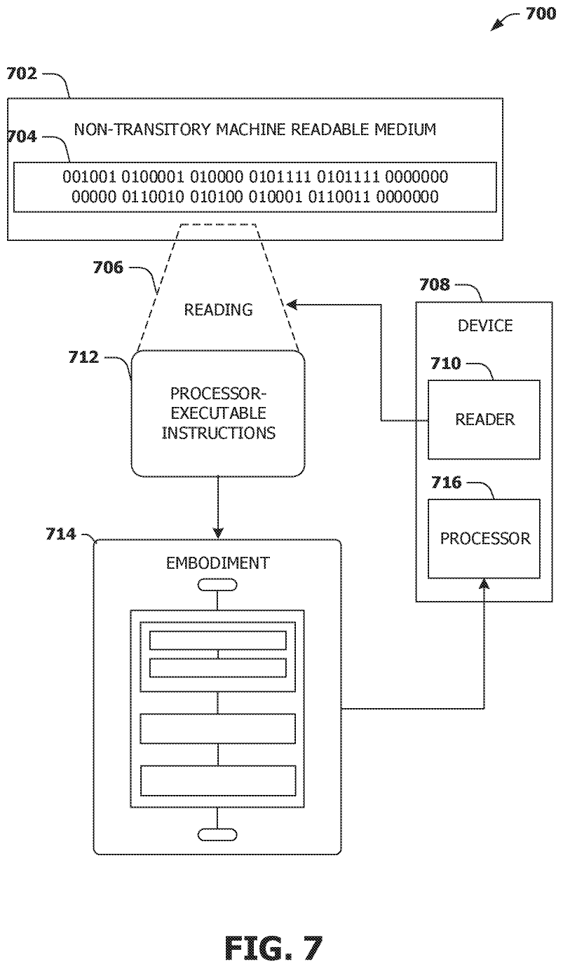

FIG. 7 is an illustration of a scenario 700 involving an example non-transitory machine readable medium 702. The non-transitory machine readable medium 702 may comprise processor-executable instructions 712 that when executed by a processor 716 cause performance (e.g., by the processor 716) of at least some of the provisions herein (e.g., embodiment 714). The non-transitory machine readable medium 702 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 702 stores computer-readable data 704 that, when subjected to reading 706 by a reader 710 of a device 708 (e.g., a read head of a hard disk drive, or a read operation invoked on a solid-state storage device), express the processor-executable instructions 712. In some embodiments, the processor-executable instructions 712, when executed, cause performance of operations, such as at least some of the example method 400 of FIGS. 4A-4B, for example. In some embodiments, the processor-executable instructions 712 are configured to cause implementation of a system, such as at least some of the example system 501 of FIGS. 5A-5C and/or at least some of the example system 601 of FIGS. 6A-6F, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
analyzing activity associated with a first plurality of client devices based upon one or more first content items to determine:
one or more first time periods during which the one or more first content items are trending; and
one or more second time periods during which the one or more first content items are not trending;
analyzing a user profile database based upon the one or more first content items, the one or more first time periods and the one or more second time periods to identify:
a first plurality of user profiles associated with a first set of client devices, wherein a user profile of the first plurality of user profiles comprises activity information, associated with a client device of the first set of client devices, indicative of activity associated with a content item of the one or more first content items within the one or more first time periods; and
a second plurality of user profiles associated with a second set of client devices, wherein a user profile of the second plurality of user profiles comprises activity information, associated with a client device of the second set of client devices, indicative of activity associated with a content item of the one or more first content items within the one or more second time periods;
determining, based upon the first plurality of user profiles, a first conversion score associated with a first entity, wherein the first conversion score is associated with a measure of conversion events associated with the first entity occurring after activity associated with the one or more first content items is performed within the one or more first time periods;
determining, based upon the second plurality of user profiles, a second conversion score associated with the first entity, wherein the second conversion score is associated with a measure of conversion events associated with the first entity occurring after activity associated with the one or more first content items is performed within the one or more second time periods;
receiving a request for content associated with a first client device;
analyzing the user profile database to identify a first user profile associated with the first client device, wherein the first user profile comprises first activity information associated with the first client device;
responsive to determining that the first activity information is indicative of first activity associated with a content item of the one or more first content items, determining a conversion probability associated with the first client device based upon at least one of the first conversion score or the second conversion score, wherein the conversion probability corresponds to a probability that a conversion event associated with the first entity is performed via the first client device;
selecting a transmission content item for transmission to the first client device based upon the conversion probability; and
transmitting the transmission content item to the first client device.

2. The method of claim 1, wherein the analyzing the activity associated with the first plurality of client devices based upon the one or more first content items to determine the one or more first time periods and the one or more second time periods comprises:
determining, based upon the activity associated with the first plurality of client devices, that one or more first levels of activity associated with the one or more first content items within the one or more first time periods meets a threshold level of activity; and
determining, based upon the activity associated with the first plurality of client devices, that a second level of activity associated with the one or more first content items within the one or more second time periods does not meet the threshold level of activity.

3. The method of claim 1, wherein:
the determining the conversion probability associated with the first client device is performed based upon the first conversion score responsive to a determination that the first activity associated with the content item of the one or more first content items is performed at a time that the one or more first content items are trending.

4. The method of claim 1, wherein:
the determining the conversion probability associated with the first client device is performed based upon the second conversion score responsive to a determination that the first activity associated with the content item of the one or more first content items is performed at a time that the one or more first content items are not trending.

5. The method of claim 1, wherein:
the first conversion score is associated with a first conversion rate, associated with conversion events associated with the first entity, of the first set of client devices; and
the second conversion score is associated with a second conversion rate, associated with conversion events associated with the first entity, of the second set of client devices.

6. The method of claim 1, wherein the determining the first conversion score associated with the first entity comprises:
analyzing the user profile database to determine a first conversion rate, associated with the first entity, of the first plurality of client devices; and
analyzing the first plurality of user profiles associated with the first set of client devices to determine a second conversion rate, associated with the first entity, of the first set of client devices, wherein the determining the first conversion score is performed based upon the first conversion rate and the second conversion rate.

7. The method of claim 6, comprising:
determining a first total quantity of user profiles of a third plurality of user profiles of the user profile database, wherein the third plurality of user profiles is associated with the first plurality of client devices, wherein the third plurality of user profiles comprises the first plurality of user profiles and the second plurality of user profiles;
analyzing the user profile database to determine a first quantity of user profiles of a first set of user profiles, of the third plurality of user profiles, indicative of conversion events associated with the first entity, wherein the first conversion rate is determined based upon the first total quantity of user profiles and the first quantity of user profiles;
determining a second total quantity of user profiles of the first plurality of user profiles; and
analyzing the first plurality of user profiles to determine a second quantity of user profiles of a second set of user profiles, of the first plurality of user profiles, indicative of conversion events associated with the first entity, wherein the second conversion rate is determined based upon the second total quantity of user profiles and the second quantity of user profiles.

8. The method of claim 1, wherein the determining the second conversion score associated with the first entity comprises:
analyzing the user profile database to determine a first conversion rate, associated with the first entity, of the first plurality of client devices; and
analyzing the second plurality of user profiles associated with the second set of client devices to determine a second conversion rate, associated with the first entity, of the second set of client devices, wherein the determining the second conversion score is performed based upon the first conversion rate and the second conversion rate.

9. The method of claim 8, comprising:
determining a first total quantity of user profiles of a third plurality of user profiles of the user profile database, wherein the third plurality of user profiles is associated with the first plurality of client devices, wherein the third plurality of user profiles comprises the first plurality of user profiles and the second plurality of user profiles;
analyzing the user profile database to determine a first quantity of user profiles of a first set of user profiles, of the third plurality of user profiles, indicative of conversion events associated with the first entity, wherein the first conversion rate is determined based upon the first total quantity of user profiles and the first quantity of user profiles;
determining a second total quantity of user profiles of the second plurality of user profiles; and
analyzing the second plurality of user profiles to determine a second quantity of user profiles of a second set of user profiles, of the second plurality of user profiles, indicative of conversion events associated with the first entity, wherein the second conversion rate is determined based upon the second total quantity of user profiles and the second quantity of user profiles.

10. The method of claim 1, comprising:
analyzing a first content item to determine that the first content item is associated with a first subject;
analyzing a second content item to determine that the second content item is associated with the first subject; and
selecting the first content item and the second content item for inclusion in the one or more first content items based upon the first content item and the second content item being associated with the first subject.

11. The method of claim 1, wherein:
the determining the first conversion score associated with the first entity is performed based upon a duration of time of the one or more first time periods.

12. A computing device comprising:
a processor; and
memory comprising processor-executable instructions that when executed by the processor cause performance of operations, the operations comprising:
analyzing activity associated with a first plurality of client devices based upon one or more first content items to determine:
one or more first time periods during which the one or more first content items are trending; and
one or more second time periods during which the one or more first content items are not trending;
analyzing a user profile database based upon the one or more first content items, the one or more first time periods and the one or more second time periods to identify:
a first plurality of user profiles associated with a first set of client devices, wherein a user profile of the first plurality of user profiles comprises activity information, associated with a client device of the first set of client devices, indicative of activity associated with a content item of the one or more first content items within the one or more first time periods; and
a second plurality of user profiles associated with a second set of client devices, wherein a user profile of the second plurality of user profiles comprises activity information, associated with a client device of the second set of client devices, indicative of activity associated with a content item of the one or more first content items within the one or more second time periods;
determining, based upon the first plurality of user profiles, a first conversion score associated with a first entity, wherein the first conversion score is associated with a measure of conversion events associated with the first entity occurring after activity associated with the one or more first content items is performed within the one or more first time periods; and
determining, based upon the second plurality of user profiles, a second conversion score associated with the first entity, wherein the second conversion score is associated with a measure of conversion events associated with the first entity occurring after activity associated with the one or more first content items is performed within the one or more second time periods.

13. The computing device of claim 12, wherein the analyzing the activity associated with the first plurality of client devices based upon the one or more first content items to determine the one or more first time periods and the one or more second time periods comprises:
determining, based upon the activity associated with the first plurality of client devices, that one or more first levels of activity associated with the one or more first content items within the one or more first time periods meets a threshold level of activity; and
determining, based upon the activity associated with the first plurality of client devices, that a second level of activity associated with the one or more first content items within the one or more second time periods does not meet the threshold level of activity.

14. The computing device of claim 12, the operations comprising:
receiving a request for content associated with a first client device;
analyzing the user profile database to identify a first user profile associated with the first client device, wherein the first user profile comprises first activity information associated with the first client device;
responsive to determining that the first activity information is indicative of first activity associated with a content item of the one or more first content items performed at a time that the one or more first content items are trending, determining a conversion probability associated with the first client device based upon the first conversion score, wherein the conversion probability corresponds to a probability that a conversion event associated with the first entity is performed via the first client device;
selecting a transmission content item for transmission to the first client device based upon the conversion probability; and
transmitting the transmission content item to the first client device.

15. The computing device of claim 12, the operations comprising:
receiving a request for content associated with a first client device;
analyzing the user profile database to identify a first user profile associated with the first client device, wherein the first user profile comprises first activity information associated with the first client device;
responsive to determining that the first activity information is indicative of first activity associated with a content item of the one or more first content items performed at a time that the one or more first content items are not trending, determining a conversion probability associated with the first client device based upon the second conversion score, wherein the conversion probability corresponds to a probability that a conversion event associated with the first entity is performed via the first client device;
selecting a transmission content item for transmission to the first client device based upon the conversion probability; and
transmitting the transmission content item to the first client device.

16. A non-transitory machine readable medium having stored thereon processor-executable instructions that when executed cause performance of operations, the operations comprising:
analyzing activity associated with a first plurality of client devices based upon one or more first content items to determine:
one or more first time periods during which the one or more first content items are trending; and
one or more second time periods during which the one or more first content items are not trending;
analyzing a user profile database based upon the one or more first content items, the one or more first time periods and the one or more second time periods to identify:
a first plurality of user profiles associated with a first set of client devices, wherein a user profile of the first plurality of user profiles comprises activity information, associated with a client device of the first set of client devices, indicative of activity associated with a content item of the one or more first content items within the one or more first time periods; and
a second plurality of user profiles associated with a second set of client devices, wherein a user profile of the second plurality of user profiles comprises activity information, associated with a client device of the second set of client devices, indicative of activity associated with a content item of the one or more first content items within the one or more second time periods;
determining, based upon the first plurality of user profiles, a first conversion score associated with a first entity, wherein the first conversion score is associated with a measure of conversion events associated with the first entity occurring after activity associated with the one or more first content items is performed within the one or more first time periods;
determining, based upon the second plurality of user profiles, a second conversion score associated with the first entity, wherein the second conversion score is associated with a measure of conversion events associated with the first entity occurring after activity associated with the one or more first content items is performed within the one or more second time periods; and
generating a summary report based upon at least one of the first conversion score, the second conversion score, the one or more first content items, the first plurality of user profiles or the second plurality of user profiles.

17. The non-transitory machine readable medium of claim 16, wherein:
the summary report is indicative of at least one of the first conversion score, the second conversion score, the one or more first content items, the first plurality of user profiles or the second plurality of user profiles.

18. The non-transitory machine readable medium of claim 16, the operations comprising:
transmitting the summary report to a client device associated with the first entity.

19. The non-transitory machine readable medium of claim 16, wherein the determining the first conversion score associated with the first entity comprises:
analyzing the user profile database to determine a first conversion rate, associated with the first entity, of the first plurality of client devices; and
analyzing the first plurality of user profiles associated with the first set of client devices to determine a second conversion rate, associated with the first entity, of the first set of client devices, wherein the determining the first conversion score is performed based upon the first conversion rate and the second conversion rate.

20. The non-transitory machine readable medium of claim 16, wherein the determining the second conversion score associated with the first entity comprises:
analyzing the user profile database to determine a first conversion rate, associated with the first entity, of the first plurality of client devices; and
analyzing the second plurality of user profiles associated with the second set of client devices to determine a second conversion rate, associated with the first entity, of the second set of client devices, wherein the determining the second conversion score is performed based upon the first conversion rate and the second conversion rate.
